(19) United States
(12) Patent Application Publication
(10) Pub. No.: US 2025/0040568 A1
(43) Pub. Date: Feb. 6, 2025

(54) COARSE FIBER COMPOSITION

(71) Applicant: DUYNIE HOLDING BV, Nijmegen (NL)

(72) Inventors: Joost VAN DEN ELZEN, Nijmegen (NL); Jurgen MEIJER, Nijmegen (NL); Tom VERHOEK, Nijmegen (NL); Joris ZOETENDAAL, Nijmegen (NL); Marcel LOMMERS, Nijmegen (NL)

(21) Appl. No.: 18/715,600

(22) PCT Filed: Dec. 2, 2022
(86) PCT No.: PCT/IB2022/061700

§ 371 Date: May 31, 2024

(30) Foreign Application Priority Data
Dec. 2, 2021 (BE) 2021/5936

(51) Int. Cl. A23J 1/00; A23J 1/12

(52) U.S. Cl. CPC A23J 1/005; A23J 1/12

(57) ABSTRACT

The invention pertains to a coarse fiber composition comprising coarse fibers of cereal grains, characterized in that the coarse fiber composition comprises at least 65 wt % (wt %) insoluble high molecular weight dietary fibers (insoluble HMWDF) and less than 15 wt % protein, based on the total dry weight of the coarse fiber composition.

The present invention relates to a coarse fiber composition. Furthermore, the invention relates to a fine fiber composition and a protein-containing composition. The invention further relates to a method for recovering protein-rich concentrate and low-nitrogen fibers from cereal grains and an apparatus for applying this method.

Cereal spent grains or cereal grains is a common by-product in breweries or distilleries and also includes brewer's grains. Examples of suitable cereals include maize, rice, wheat, barley, sorghum, millet, oat and rye. The preferred cereal in this invention is barley, and in particular the brewer's grain or brewer's spent grain. In general, malted barley is used as a raw material for brewing beer. However, it is clear that the invention as described below is not limited to malted barley and/or brewer's spent grain, but may also include other raw materials, which may or may not be used in combination with malted barley.

More specifically, the invention is intended for processing the residual cereal grain into a high-quality protein concentrate for monogastric farm animals, fish farming, animal feed and human food, but also into low-nitrogen fibers suitable for short-cycle biomass for renewable energy generation or other applications without burdening the environment with nitrogen.

In addition, the invention is also intended for processing the residual product cereal grains into dietary fibers for human and animal food as well as into building material.

It is known that in the fermentation of grains for the production of beer, distilled beverages, consumption alcohol and/or bioethanol, the largest co-product stream is cereal spent grain. In a brewery, this cereal spent grain is usually called brewer's grain. This brewer's grain is also called trot and is also known as “Brewer's Spent Grain” (BSG). The raw material from which beer is brewed consists mainly of barley and the cereal grain that remains has an average composition of 18-25% dry matter, of which 10-35% protein, 5-15% fats and 65-75% fiber on a dry matter basis.

EP 0 443 813 A1 (1991) already describes a process for obtaining a protein-rich product from cereal grains, in which the cereal grains are mixed with water, and passed through a roller press to separate the protein-rich fraction from the chaff, after which both fractions are separated from several sieving steps.

CA 2 155 042 (1995) also describes a process for obtaining a protein-rich product from cereal grains, in which the cereal grains are mixed with water and passed through a press, preferably a roller press, to separate the protein-rich fraction from the chaff, followed by a dewatering step through a centrifuge, a drum filter, a leaf filter or a filter press. The protein-containing phase, rich in solids, is kept at a temperature below 100° C., then dried in a period of less than 60 seconds by means of hot air, preferably at 400-450° C., and further processed into animal feed or human food. The separated chaff is burned and the heat is recovered.

WO 2008/010156 A2 (2008) also discloses a process to treat, inter alia, cereal grains by brushing and combing the plant material in a wet state, instead of grinding pre-dried plant material in a multi-stage process, with the aim of extracting the plant material to be separated into a fiber-rich product stream and a protein-rich product stream. Chemicals such as alkali metal hydroxides are used to break open the fiber fraction, and peroxide, ozone or hypochlorite to bleach which chemicals are less environmentally friendly.

EP 3831212 A1 (2021) discloses a method and apparatus for producing a protein suspension from brewer's grains. The process comprises two stages, one in a colloid mill and one in a screw extractor, without compression steps and without thermochemical treatment, and allows to obtain a protein product, in an enzymatic and/or alkaline way, with a protein content of at least 50% of the dry matter.

Traditionally, spent grains are used as animal feed, as an energy source through fermentation or combustion or as an addition to agricultural land as fertilizer, or the product, both aleurone and endosperm, is disposed of as waste and not recycled because it has insufficient nutritional value to be used as animal feed. During this processing, an excessive amount of nitrogen-comprising compounds ends up in the environment, which leads to unacceptable environmental pollution.

The present invention aims to solve at least one of the foregoing and other drawbacks by providing a method that allows to recover protein-rich concentrate and low-nitrogen fibers from cereal grains and to recycle them in an environmentally friendly manner without the use of aggressive chemicals.

To this end, the invention relates to a coarse fiber composition and a fine fiber composition and a protein-containing composition. In addition, the invention relates to a method for recovering the coarse and fine fiber composition and the protein-containing composition from cereal grains, preferably brewer's spent grain. The process of milling a suspension of cereal grains, preferably brewer's spent grain, allows more protein to be recovered from the fibers, and in particular from the aleurone layer and the endosperm layer, and thereby more protein is generally recovered and moreover a fiber fraction with a low nitrogen content can be obtained.

In this context, unprocessed cereal grains are understood to mean cereal grains from which the coarse fiber composition and/or the fine fiber composition and/or the protein-containing composition originate. By unprocessed brewer's spent grain is here meant the brewer's grain from which the coarse fiber composition and/or the fine fiber composition and/or the protein-containing composition originate.

### The Coarse Fiber Composition

The invention relates to a coarse fiber composition obtained from cereal spent grains, preferably from brewer's spent grains. In an embodiment of the invention, the coarse fiber composition comprises coarse fibers of cereal grains, preferably brewer's spent grain, wherein the coarse fiber composition comprises a maximum of 15% by weight (wt. %) of proteins, a minimum of 20% by weight of cellulose, a minimum of 40% by weight of hemicellulose and a minimum of 4 wt % lignin, based on the total dry weight of the coarse fiber composition. Alternatively or additionally, the invention relates to a coarse fiber composition comprising at least 65 wt % (wt %) insoluble high molecular weight dietary fibers (insoluble HMWDF) and less than 15 wt % protein, based on the total dry weight of the coarse fiber composition.

In the context of this application the wording “total dry weight” refers to the total weight of the composition without the amount of water. The amount of water can be determined using conventional techniques, and subsequently subtracted from the total weight of the composition. Alternatively, water can be removed by drying for instance, which leaves the dry matter of the composition and hence the total dry weight of the composition.

The insoluble high molecular weight dietary fibers (insoluble HMWDF) can be determined using the standard method AOAC 2011.25 dietary fiber analysis, with which the insoluble HMWDF, the soluble HMWDF and the low molecular weight dietary fibers (LMWDF) can be determined.

An advantage of this coarse fiber composition is that it comprises less nitrogen, which results in better combustion of this fiber composition and fewer undesirable by-products such as nitrogen oxide are formed. In addition, this coarse fiber composition comprises a higher nutritional value, so that the nutritional value of food products in which the coarse fiber composition is incorporated is also higher. For example, the coarse fiber composition can be processed in bread and can partly or completely replace flour. In addition, this coarse fiber composition is relatively difficult to digest and can serve as food for intestinal flora promoting bacteria in the small intestine. Moreover, this coarse fiber composition is a natural product that is biodegradable and non-toxic to humans, animals and the environment. Another advantage is that the aforementioned coarse fiber composition is obtained from a waste or side stream, whereby this waste stream can be upgraded to a valuable and useful product with multifunctional applications.

Characteristic of the coarse fiber composition is that the ratio of cellulose to the polymer composition of cellulose and hemicellulose and lignin of the coarse fiber composition is lower than the ratio of cellulose to the polymer composition of cellulose and hemicellulose and lignin of the raw cereal spent grain.

The term “NDF” is known as “Neutral Detergent Fiber”, which includes cellulose, hemicellulose and lignin. The term “ADF” refers to “Acid Detergent Fiber” and includes cellulose and lignin. For the determination of the amount of lignin the term “ADL” is used which refers to “Acid Detergent Lignin”. The ADF and ADL values were determined according to the standard method NEN-ISO 13906:2008, and the NDF value was determined according to the standard method NEN-ISO 16472:2006.

The coarse fiber composition comprises at most 15 wt % protein, preferably at most 14 wt % proteins, more preferably at most 12 wt % proteins, even more preferably at most 10 wt % proteins, even more preferably at most 8 wt % and most preferably at most 6 wt %, and preferably at least 0.01 wt % protein, more preferably at least 0.1 wt % protein, even more preferably at least 1 wt % proteins, even more preferably at least 2 wt % proteins and most preferably at least 5 wt % proteins, based on the total dry weight of the coarse fiber composition. Various methods have been described in literature to determine the protein content. For the purposes of this application, the Kjeldahl method is used to determine the nitrogen content, which is then converted to protein content. The Kjeldahl is well established and well known to the person skilled in the art. In this application the Kjeldahl method is performed by hydrolyzing a sample using H₂SO₄ at 420° C. for 2 hours, during which the proteins will be converted to ammonia. The generated ammonia is distilled off and the amount of nitrogen is measured by titration. The amount of protein is calculated by multiplying the nitrogen content by the conversion factor of 6.25 (nitrogen to protein factor).

In another embodiment of the invention, the coarse fiber composition preferably comprises at least 70 wt % insoluble HMWDF, more preferably at least 75 wt % insoluble HMWDF, and preferably up to 99 wt % insoluble HMWDF, more preferably up to 95 wt % insoluble HMWDF, and most preferably up to 90 wt % insoluble HMWDF, based on the total dry weight of the coarse fiber composition.

In one embodiment, the coarse fiber composition comprises at least 10% of empty aleurone cells, based on the total number of aleurone cells. With the term “empty aleurone cells” is meant aleurone cells that do not contain protein. The aleurone layer comprises the aleurone cells which are cells having a cell wall and comprising protein and lipids. In conventional processes, these aleurone cells are generally not broken down and the proteins captured inside these cells generally remain a part of the coarse fiber fraction. With the process of the invention, these aleurone cell walls can be disrupted to allow the protein from being separated thereby obtaining a coarse fiber composition with a low(er) amount of protein. Moreover, the coarse fiber composition generally comprises a higher number of empty aleurone cells, which can be visualized using microscopy in particular confocal scanning laser microscopy with the fluorescent dye Nile Blue or using autofluorescence. A preferred method of confocal scanning laser microscopy is described by Filippidi et al (2014; doi: 10.1002/adfm.201400359). It is noted that empty aleurone cells can be observed as intact cells or as part of cells; both intact and partial aleurone cells that do not contain protein should be considered when counting the number of empty aleurone cells. It is noted that the aleurone cells and cell walls as well as the protein need to be present in the microscopic image. The percentage of such empty cells can be determined by counting the number of empty cells or open cells (no red coloured protein present) and the number of aleurone cells containing protein (indicated by a red mass inside the cell walls); the percentage of empty aleurone cells is calculated by dividing the number of empty cells by the total number of aleurone cells). Preferably, the coarse fiber composition comprises at least 15% of empty aleurone cells, more preferably at least 20% of empty aleurone cells, even more preferably at least 30% of empty aleurone cells, even more preferably at least 40% of empty aleurone cells and most preferably at least 50% of empty aleurone cells, based on the total number of aleurone cells, and preferably at most 100% of empty aleurone cells, more preferably at most 95% of empty aleurone cells, more preferably at most 90% of empty aleurone cells, more preferably at most 80% of empty aleurone cells and most preferably at most 70% of empty aleurone cells, based on the total number of aleurone cells.

Additionally or alternatively, the amount of protein present in the aleurone cells can be established by determining the area of the protein particles in aleurone cells and relate these areas to the total area of the empty and filled aleurone cells using the microscopic method described above and a software capable of determining the area of the protein particles and the aleurone cells. The ratio of the total area of the protein particles and the total area of aleurone cells is referred to as the “protein to aleurone cell area ratio”. In one embodiment, the coarse fiber composition comprises a protein to aleurone cell area ratio of at most 0.9. Preferably, the protein to aleurone cell area ratio is at most 0.8, more preferably at most 0.7, even more preferably at most 0.6 and most preferably at most 0.5, and preferably at least 0.001, more preferably at least 0.01 and most preferably at least 0.1.

Additionally or alternatively, the amount of protein present in the aleurone cells (encapsulated protein) can be established by determining the area of the protein particles in aleurone cells and the amount of free protein can be established by determining the area of the protein particles not present in aleurone cells using the microscopic method described above and a software capable of determining the area of the free and encapsulated protein particles. The total amount of protein refers to the sum of free protein and encapsulated protein. It is noted that the amount of free protein, encapsulated protein and total amount of protein can also be determined using scanning electron microscopy (vide infra). In one embodiment, the coarse fiber composition comprises at least 0.01% of free protein, more preferably at least 0.1% of free protein, even more preferably at least 0.2% of free protein, even more preferably at least 0.5% of free protein and most preferably at least 1% of free protein, based on the total amount of protein, and preferably at most 20% of free protein, more preferably at most 15% of free protein, more preferably at most 10% of free protein, more preferably at most 8% of free protein and most preferably at most 5% of free protein, based on the total amount of protein.

In one embodiment, the coarse fiber composition comprises at least 20% of encapsulated protein, more preferably at least 30% of encapsulated protein, even more preferably at least 40% of encapsulated protein, even more preferably at least 50% of encapsulated protein and most preferably at least 60% of encapsulated protein, based on the total amount of protein, and preferably at most 99.99% of encapsulated protein, more preferably at most 99% of encapsulated protein, more preferably at most 95% of encapsulated protein, more preferably at most 90% of encapsulated protein and most preferably at most 80% of encapsulated protein, based on the total amount of protein.

Additionally or alternatively, the presence and amount of intact cells, ruptured cells and free protein can be determined using electron microscopy, preferably scanning electron microscopy (SEM). With “intact cells” is meant the aleurone cells with complete cell walls and containing cytoplasmic protein; in a SEM image the cell walls have a bright color compared to background and cytoplasmic compounds (including protein). With “ruptured cells” is meant the aleurone cells with incomplete cell walls (cell is open but not fully disintegrated) which may contain or not contain cytoplasmic compounds and the aleurone cells with complete cell walls which do not contain cytoplasmic compounds. The total number of aleurone cells is defined as the sum of intact cells and ruptured cells. With “free protein” is meant the cytoplasmic compounds without outer cell wall layers (i.e. without intact or ruptured cell walls surrounding the cytoplasmic compounds). A preferred method of determining the number of intact cells, ruptured cells and free protein is described in Example 1. In one embodiment, the coarse fiber composition comprises at least 20% of ruptured cells, based on the total number of aleurone cells. Preferably, the coarse fiber composition comprises at least 25% of ruptured cells, more preferably at least 30% of ruptured cells, even more preferably at least 35% of ruptured cells, even more preferably at least 40% of ruptured cells and most preferably at least 50% of ruptured cells, based on the total number of aleurone cells, and preferably at most 100% of ruptured cells, more preferably at most 95% of ruptured cells, more preferably at most 90% of ruptured cells, more preferably at most 80% of ruptured cells and most preferably at most 70% of ruptured cells, based on the total number of aleurone cells.

In one embodiment, the coarse fiber composition comprises at most 80% of intact cells, based on the total number of aleurone cells. Preferably, the coarse fiber composition comprises at most 75% of intact cells, more preferably at most 70% of intact cells, even more preferably at most 65% of intact cells, even more preferably at most 60% of intact cells and most preferably at most 50% of intact cells, based on the total number of aleurone cells, and preferably at most no intact cells, more preferably at least 5% of intact cells, more preferably at least 10% of intact cells, more preferably at least 20% of intact cells and most preferably at least 30% of intact cells, based on the total number of aleurone cells.

In one embodiment, the coarse fiber composition comprises at least 22 wt % cellulose, more preferably at least 24 wt % cellulose and preferably at most 40 wt % cellulose, more preferably at most 35 wt % cellulose and most preferably at most 30 wt % cellulose, based on the total dry weight of the coarse fiber composition.

In one embodiment, the coarse fiber composition comprises at least 40% wt % hemicellulose, more preferably at least 45 wt % hemicellulose and most preferably at least 50 wt % hemicellulose, and preferably at most 65 wt % hemicellulose, more preferably at most 60 wt % hemicellulose and most preferably at most 55 wt % hemicellulose, based on the total dry weight of the coarse fiber composition.

In one embodiment of the invention, the weight ratio of hemicellulose and cellulose in the coarse fiber composition is at least 1.5, more preferably at least 1.8 and most preferably at least 2.0, and preferably at most 2.5, more preferably at most 2.2 and most preferably at most 2.1.

In one embodiment of the invention, the weight ratio of hemicellulose and lignin in the coarse fiber composition is at least 8.5, more preferably at least 9.0 and most preferably at least 9.2, and preferably at most 10.0, more preferably at most 9.9 and most preferably at most 9.8.

In one embodiment of the invention, the weight ratio of cellulose and lignin in the coarse fiber composition is at least 4.0, more preferably at least 4.2 and most preferably at least 4.5, and preferably at most 6.0, more preferably at most 5.5 and most preferably at most 5.0.

In one embodiment of the invention, the weight ratio of protein and fat in the coarse fiber composition is at least 1.0, more preferably at least 1.1 and most preferably at least 1.2, and preferably at most 2.2, more preferably at most 2.0 and most preferably at most 1.8.

In addition, the coarse fiber composition preferably comprises at least 1 wt % fat, more preferably at least 2 wt % fat and most preferably at least 5 wt % fat, and preferably at most 10 wt % fat, more preferably at most 9 wt % fat and most preferably at most 8 wt % fat, based on the total dry weight of the coarse fiber composition. The amount of fat can be determined with methods known in the art including organic solvent extraction. An example of such a technique is the ISO 6492 method.

In addition, the coarse fiber composition preferably comprises at most 5 wt % ash, more preferably at most 4 wt % ash and most preferably at most 3 wt % ash, and preferably at least 0.1 wt % ash, more preferably at least 0.5 wt % ash and most preferably at least 1 wt % ash, based on the total dry weight of the coarse fiber composition. Ash content is determined using the ISO 5984:2002 method.

In addition, the coarse fiber composition preferably comprises at least 20 wt % crude fiber, more preferably at least 22 wt % crude fiber and most preferably at least 25 wt % crude fiber, and preferably at most 40 wt % crude fiber, more preferably at most 35 wt % crude fiber and most preferably at most 30 wt % crude fiber, based on the total dry weight of the coarse fiber composition. The crude fiber is determined using the ISO 68651:2000 method.

In one embodiment, the coarse fiber composition of the invention comprises particles having a d90 value of at most 500 μm. Preferably, the particles have a d90 value of at most 400 μm, preferably at most 300 μm, more preferably at most 200 μm, even more preferably at most 150 μm, even more preferably at most 125 μm, even more preferably at most 100 μm, and most preferably at most 75 μm, and at least 1 μm, preferably at least 2 μm, more preferably at least 5 μm and most preferably at least 10 μm. The particle size distribution, in particular the d90 value, is determined using conventional techniques such as laser diffraction using a Malvern Mastersizer.

In a further embodiment, the coarse fiber composition comprises at most 10 wt % water. Preferably, the coarse fiber composition comprises at most 9 wt % of water, more preferably at most 8 wt %, even more preferably at most 7 wt % and most preferably at most 5 wt %, and preferably at least 0.001 wt %, more preferably at least 0.01 wt % and most preferably at least 0.1 wt %, based on the total weight of the coarse fiber composition.

The amounts of protein, fiber, lignin, fat and the other components add up to 100% by weight of the coarse fiber composition.

### The Fine Fiber Composition

The invention relates to a fine fiber composition obtained from cereal grains, preferably from brewer's spent grain. In one embodiment of the invention, the fine fiber composition comprises fine fibers of cereal grains, wherein the fine fiber composition comprises a maximum of 20% by weight cellulose, at least 40% by weight hemicellulose and at least 4% by weight lignin relative to the total dry weight of the fine fiber composition. Alternatively or additionally, the fine fiber composition of cereal grains, preferably brewer's spent grain, comprises at least 50% by weight and at most 70% by weight insoluble high molecular weight dietary fibers (HMWDF), based on the total dry weight of the fine fiber composition, and wherein the fine fiber composition comprises at most 20 wt % cellulose, based on the total dry weight of the fine fiber composition.

Such fine fiber composition can serve as a substitute for flour and can also be processed in foodstuffs.

This fine fiber composition, and in particular due to the high hemicellulose content, can be processed in, for example, baking products such as bread and/or biscuits and/or cake and/or the like and ensures a better fluffiness and/or softness and/or resilience thereof. The fine fiber composition is a natural product that is biodegradable and non-toxic to humans, animals and the environment. Another advantage is that the fine fiber composition is obtained from a waste or side stream, whereby this waste stream can be upgraded to a valuable and useful product with multifunctional applications.

The fine fiber composition comprises at most 40 wt % protein, preferably at most 35 wt % protein, even more preferably at most 30 wt % protein and most preferably at most 20 wt % protein, and preferably at least 0.01 wt % protein, more preferably at least 0.1 wt % protein, even more preferably at least 1 wt % proteins, even more preferably at least 2 wt % proteins and most preferably at least 5 wt % proteins, based on the total dry weight of the fine fiber composition.

In one embodiment of the invention, the protein of the fine fiber composition comprises at most 20 wt % glutamine, more preferably at most 19 wt % glutamine and most preferably at most 18 wt % glutamine and at least 10 wt % glutamine and more preferably at least 15 wt % glutamine from the wt % of the proteins in the fine fiber composition.

In addition, the fine fiber composition preferably comprises at least 52 wt % insoluble HMWDF, more preferably at least 55 wt % insoluble HMWDF, preferably up to 65 wt % insoluble HMWDF, more preferably up to 62 wt % insoluble HMWDF, and most preferably up to 60 wt % insoluble HMWDF, based on the total dry weight of the fine fiber composition.

In one embodiment, the fine fiber composition comprises at least 10% of empty aleurone cells, based on the total number of aleurone cells. Preferably, the fine fiber composition comprises at least 15% of empty aleurone cells, more preferably at least 20% of empty aleurone cells, even more preferably at least 30% of empty aleurone cells, even more preferably at least 40% of empty aleurone cells and most preferably at least 50% of empty aleurone cells, based on the total number of aleurone cells, and preferably at most 100% of empty aleurone cells, more preferably at most 95% of empty aleurone cells, more preferably at most 90% of empty aleurone cells, more preferably at most 80% of empty aleurone cells and most preferably at most 70% of empty aleurone cells, based on the total number of aleurone cells.

In one embodiment, the fine fiber composition comprises a protein to aleurone cell area ratio of at most 0.9. Preferably, the protein to aleurone cell area ratio is at most 0.8, more preferably at most 0.7, even more preferably at most 0.6 and most preferably at most 0.5, and preferably at least 0.001, more preferably at least 0.01 and most preferably at least 0.1.

In one embodiment, the fine fiber composition comprises at least 0.01% of free protein, more preferably at least 0.1% of free protein, even more preferably at least 0.2% of free protein, even more preferably at least 0.5% of free protein and most preferably at least 1% of free protein, based on the total amount of protein, and preferably at most 60% of free protein, more preferably at most 50% of free protein, more preferably at most 40% of free protein, more preferably at most 35% of free protein and most preferably at most 30% of free protein, based on the total amount of protein.

In one embodiment, the fine fiber composition comprises at least 1% of encapsulated protein, more preferably at least 2% of encapsulated protein, even more preferably at least 5% of encapsulated protein, even more preferably at least 10% of encapsulated protein and most preferably at least 10% of encapsulated protein, based on the total amount of protein, and preferably at most 60% of encapsulated protein, more preferably at most 50% of encapsulated protein, more preferably at most 40% of encapsulated protein, more preferably at most 35% of encapsulated protein and most preferably at most 30% of encapsulated protein, based on the total amount of protein.

In one embodiment, the fine fiber composition comprises at least 20% of ruptured cells, based on the total number of aleurone cells. Preferably, the fine fiber composition comprises at least 25% of ruptured cells, more preferably at least 30% of ruptured cells, even more preferably at least 35% of ruptured cells, even more preferably at least 40% of ruptured cells and most preferably at least 50% of ruptured cells, based on the total number of aleurone cells, and preferably at most 100% of ruptured cells, more preferably at most 95% of ruptured cells, more preferably at most 90% of ruptured cells, more preferably at most 80% of ruptured cells and most preferably at most 70% of ruptured cells, based on the total number of aleurone cells.

In one embodiment, the fine fiber composition comprises at most 80% of intact cells, based on the total number of aleurone cells. Preferably, the fine fiber composition comprises at most 75% of intact cells, more preferably at most 70% of intact cells, even more preferably at most 65% of intact cells, even more preferably at most 60% of intact cells and most preferably at most 50% of intact cells, based on the total number of aleurone cells, and preferably no intact cells, more preferably at least 5% of intact cells, more preferably at least 10% of intact cells, more preferably at least 20% of intact cells and most preferably at least 30% of intact cells, based on the total number of aleurone cells.

In one embodiment, the fine fiber composition comprises at least 1 wt % cellulose, more preferably at least 2 wt % cellulose and most preferably at least 5 wt % cellulose, and preferably at most 18 wt % cellulose, more preferably at most 17 wt % cellulose and most preferably at most 16 wt % cellulose, based on the total dry weight of the fine fiber composition.

In one further embodiment, the fine fiber composition preferably comprises at least 42% by weight hemicellulose, more preferably at least 45% by weight hemicellulose, and preferably at most 70% by weight hemicellulose, more preferably at most 65% by weight hemicellulose and most preferably at most 60% by weight hemicellulose, based on the total dry weight of the fine fiber composition.

In a further embodiment of the invention, the fine fiber composition comprises at least 2 wt % lignin, preferably at least 3.5 wt % lignin, and most preferably at least 4 wt % lignin and preferably at most 10 wt % lignin, more preferably at most 8 wt % lignin and most preferably at most 6 wt % lignin, based on the total dry weight of the fine fiber composition.

In one embodiment, the fine fiber composition comprises at most 20% by weight cellulose, at least 40% by weight hemicellulose and at least 4% by weight lignin, based on the total dry weight of the fine fiber composition. However, it is also possible that the fine fiber composition comprises at least 3 wt % lignin, based on the total dry weight of the fine fiber composition.

In one embodiment of the invention, the weight ratio of hemicellulose and cellulose in the fine fiber composition is at least 2.0, more preferably at least 2.2 and most preferably at least 2.5, and preferably at most 4.0, more preferably at most 3.5 and most preferably at most 3.0.

In one embodiment of the invention, the weight ratio of hemicellulose and lignin in the fine fiber composition is at least 9.0, more preferably at least 9.2 and most preferably at least 9.5, and preferably at most 10.5, more preferably at most 10.0 and most preferably at most 9.8.

In one embodiment of the invention, the weight ratio of cellulose and lignin in the fine fiber composition is at least 2.0, more preferably at least 2.5 and most preferably at least 3.0, and preferably at most 4.5, more preferably at most 4.0 and most preferably at most 3.5.

In one embodiment of the invention, the weight ratio of protein and fat in the fine fiber composition is at least 2.0, more preferably at least 2.2 and most preferably at least 2.5, and preferably at most 4.0, more preferably at most 3.5 and most preferably at most 3.0.

In one embodiment, the fine fiber composition preferably comprises at least 1 wt % fat, more preferably at least 5 wt % fat and most preferably at least 8 wt % fat, and preferably at most 18 wt % fat, more preferably at most 15 wt % fat and most preferably at most 12 wt % fat, based on the total dry weight of the fine fiber composition. The amount of fat can be determined with methods known in the art including organic solvent extraction. An example of such a technique is the ISO 6492 method.

In a further embodiment of the invention, the fine fiber composition comprises at most 5 wt % ash, more preferably at most 4 wt % ash and most preferably at most 3 wt % ash, and preferably at least 0.1 wt % ash, more preferably at least 0.5 wt % ash and most preferably at least 1 wt % ash, based on the total dry weight of the fine fiber composition. Ash content is determined using the ISO 5984:2002 method.

In one embodiment, the fine fiber composition comprises at least 5 wt % crude fiber, more preferably at least 10 wt % crude fiber and most preferably at least 15 wt % crude fiber, and preferably at most 30 wt % crude fiber, more preferably at most 25 wt % crude fiber and most preferably at most 20 wt % crude fiber, based on the total dry weight of the fine fiber composition. The crude fiber is determined using the ISO 68651:2000 method.

In one embodiment, the fine fiber composition of the invention comprises particles having a d90 value of at most 200 μm. Preferably, the particles have a d90 value of at most 150 μm, preferably at most 125 μm, more preferably at most 100 μm, even more preferably at most 75 μm, even more preferably at most 50 μm, and most preferably at most 40 μm, and at least 1 μm, preferably at least 2 μm, more preferably at least 5 μm and most preferably at least 10 μm. The particle size distribution, in particular the d90 value, is determined using conventional techniques such as laser diffraction using a Malvern Mastersizer.

In a further embodiment, the fine fiber composition comprises at most 10 wt % water. Preferably, the fine fiber composition comprises at most 9 wt % of water, more preferably at most 8 wt %, even more preferably at most 7 wt % and most preferably at most 5 wt %, and preferably at least 0.001 wt %, more preferably at least 0.01 wt % and most preferably at least 0.1 wt %, based on the total dry weight of the fine fiber composition.

The amounts of protein, fiber, lignin, fat and the other components add up to 100% by weight of the fine fiber composition.

### The Protein-Containing Composition

The invention relates to a protein-containing composition obtained from cereal grains, preferably from brewer's spent grain. In an embodiment of the invention, the protein-containing composition comprises proteins from cereal grains, which protein-containing composition comprises at least 50% by weight proteins and at most 1% by weight lignin, based on the total dry weight of the protein-containing composition. Alternatively or additionally, the protein-containing composition comprises at most 30% by weight of insoluble HMWDF, based on the total dry weight of the protein-containing composition.

An advantage of such a protein-containing composition is that such a composition has a high nutritional value and comprises a very high percentage of proteins, so that it can be processed, inter alia, in foods with a high protein content such as protein bars, protein-rich bread and the like. Another advantage of the protein-containing composition is that it has a good emulsifying effect and can thus have a “pickering” effect on emulsions. The protein-containing composition is a natural product that is biodegradable and non-toxic to humans, animals and the environment. The protein-containing composition can also contribute to the structural composition of food products in which they are or are incorporated, for example to the elasticity and greater firmness/firmness. Another advantage is that the protein-containing composition is obtained from a waste stream, whereby this waste stream can be upgraded to a valuable and useful product with multifunctional applications.

In one embodiment, the protein-containing composition preferably comprises mainly insoluble proteins. Preferably, the protein-containing composition comprises solely insoluble proteins.

The protein-containing composition comprises at least 50 wt % protein, based on the total dry weight of the protein-containing composition. Preferably, the protein-containing composition comprises at most 99 wt % protein, more preferably at most 95 wt % protein, and most preferably at most 90 wt % protein, and preferably at least 55 wt % protein, more preferably at least 60 wt % of protein, based on the total dry weight of the protein-containing composition.

In a further embodiment, the aforementioned protein-containing composition comprises at least 15% by weight of glutamine, based on the total dry weight of proteins in the protein-containing composition. Preferably, the proteins of the protein-containing composition comprise at most 25 wt % glutamine, more preferably at most 20 wt % glutamine and most preferably at most 15 wt % glutamine and at least 18 wt % glutamine and more preferably at least 20 wt % glutamine from the total dry weight of the proteins in the protein-containing composition.

In one embodiment, the protein-containing composition comprises at least 5% by weight of proline, based on the total dry weight of proteins in the protein-containing composition.

In a preferred variant, the protein-containing composition comprises at least 10% by weight of fat relative to the total dry weight of proteins in the protein-containing composition.

In one embodiment, the aforementioned protein-containing composition comprises at least 50% by weight of proteins and at most 1% by weight of lignin, based on the total dry weight of the protein-containing composition.

In one embodiment of the invention, the protein-containing composition comprises at least 1 wt % insoluble HMWDF, more preferably at least 5 wt % insoluble HMWDF and most preferably at least 10 wt % insoluble HMWDF, and at most 30 wt % insoluble HMWDF, more preferably at most 25 wt % insoluble HMWDF and more preferably at most 20 wt % insoluble HMWDF, based on the total dry weight of the protein-containing composition.

In one embodiment, the protein-containing composition comprises at least 10% of empty aleurone cells, based on the total number of aleurone cells. Preferably, the protein-containing composition comprises at least 15% of empty aleurone cells, more preferably at least 20% of empty aleurone cells, even more preferably at least 30% of empty aleurone cells, even more preferably at least 40% of empty aleurone cells and most preferably at least 50% of empty aleurone cells, based on the total number of aleurone cells, and preferably at most 100% of empty aleurone cells, more preferably at most 95% of empty aleurone cells, more preferably at most 90% of empty aleurone cells, more preferably at most 80% of empty aleurone cells and most preferably at most 70% of empty aleurone cells, based on the total number of aleurone cells.

In one embodiment, the protein-containing composition comprises a protein to aleurone cell area ratio of at most 0.9. Preferably, the protein to aleurone cell area ratio is at most 0.8, more preferably at most 0.7, even more preferably at most 0.6 and most preferably at most 0.5, and preferably at least 0.001, more preferably at least 0.01 and most preferably at least 0.1.

In one embodiment, the protein-containing composition comprises at least 40% of free protein, more preferably at least 50% of free protein, even more preferably at least 60% of free protein, even more preferably at least 70% of free protein and most preferably at least 75% of free protein, based on the total amount of protein, and preferably at most 99.99% of free protein, more preferably at most 99% of free protein, more preferably at most 95% of free protein, more preferably at most 90% of free protein and most preferably at most 85% of free protein, based on the total amount of protein.

In one embodiment, the protein-containing composition comprises at least 0.001% of encapsulated protein, more preferably at least 0.01% of encapsulated protein, even more preferably at least 0.05% of encapsulated protein, even more preferably at least 0.1% of encapsulated protein and most preferably at least 0.5% of encapsulated protein, based on the total amount of protein, and preferably at most 10% of encapsulated protein, more preferably at most 8% of encapsulated protein, more preferably at most 5% of encapsulated protein, more preferably at most 2% of encapsulated protein and most preferably at most 1% of encapsulated protein, based on the total amount of protein.

In one embodiment, the protein-containing composition comprises at least 20% of ruptured cells, based on the total number of aleurone cells. Preferably, the protein-containing composition comprises at least 25% of ruptured cells, more preferably at least 30% of ruptured cells, even more preferably at least 35% of ruptured cells, even more preferably at least 40% of ruptured cells and most preferably at least 50% of ruptured cells, based on the total number of aleurone cells, and preferably at most 100% of ruptured cells, more preferably at most 95% of ruptured cells, more preferably at most 90% of ruptured cells, more preferably at most 80% of ruptured cells and most preferably at most 70% of ruptured cells, based on the total number of aleurone cells. Generally, the number of ruptured cells will be higher for the protein-containing composition compared to the coarse fiber composition, while the total number of aleurone cells present in the protein-containing composition is significantly lower compared to the coarse fiber composition.

In one embodiment, the protein-containing composition comprises at most 80% of intact cells, based on the total number of aleurone cells. Preferably, the protein-containing composition comprises at most 75% of intact cells, more preferably at most 70% of intact cells, even more preferably at most 65% of intact cells, even more preferably at most 60% of intact cells and most preferably at most 50% of intact cells, based on the total number of aleurone cells, and preferably at most no intact cells, more preferably at least 5% of intact cells, more preferably at least 10% of intact cells, more preferably at least 20% of intact cells and most preferably at least 30% of intact cells, based on the total number of aleurone cells.

In one embodiment, the protein-containing composition comprises at least 0.1 wt % cellulose, more preferably at least 0.5 wt % cellulose, and most preferably at least 1 wt % cellulose, and preferably at most 10 wt % cellulose, more preferably at most 5 wt % cellulose and most preferably at most 4 wt % cellulose, based on the total dry weight of the protein-containing comprising composition.

In one additional embodiment, the protein-containing composition comprises at least 5 wt % (percent by weight) hemicellulose, more preferably at least 8 wt % hemicellulose and most preferably at least 10 wt % hemicellulose, and preferably at most 20 wt % hemicellulose, more preferably at most 17 wt % hemicellulose and most preferably at most 15 wt % hemicellulose, based on the total dry weight of the protein-containing composition.

In one embodiment of the invention, the protein-containing composition comprises at least 0.01 wt % lignin, more preferably at least 0.1 wt % lignin and most preferably at least 0.5 wt % lignin, and at most 2 wt % lignin, more preferably at most 1.5 wt % lignin and most preferably at most 1 wt % lignin, based on the total dry weight of the protein-containing composition.

In one embodiment, the protein-containing composition preferably comprises at least 10 wt % fat, more preferably at least 12 wt % fat and most preferably at least 15 wt % fat, and preferably at most 30 wt % fat, more preferably at most 25 wt % fat and most preferably at most 20 wt % fat, based on the total dry weight of the protein-containing composition.

In one embodiment of the invention, the weight ratio of hemicellulose and cellulose in the protein-containing composition is at least 2.0, more preferably at least 2.2 and most preferably at least 2.5, and preferably at most 4.0, more preferably at most 3.5 and most preferably at most 3.0.

In one embodiment of the invention, the weight ratio of hemicellulose and lignin in the protein-containing composition is at least 15, more preferably at least 18 and most preferably at least 20, and preferably at most 35, more preferably at most 30 and most preferably at most 25.

In one embodiment of the invention, the weight ratio of cellulose and lignin in the protein-containing composition is at least 5.0, more preferably at least 6.0 and most preferably at least 7.0, and preferably at most 12.0, more preferably at most 10.0 and most preferably at most 9.0.

In one embodiment of the invention, the weight ratio of protein and fat in the protein-containing composition is at least 2.5, more preferably at least 2.8 and most preferably at least 3.0, and preferably at most 5.0, more preferably at most 4.5 and most preferably at most 4.0.

In a further embodiment of the invention, the protein-containing composition comprises at most 5 wt % ash, more preferably at most 4 wt % ash and most preferably at most 3 wt % ash, and preferably at least 0.1 wt % ash, more preferably at least 0.5 wt % ash and most preferably at least 1 wt % ash, based on the total dry weight of the protein-containing composition. Ash content is determined using the ISO 5984:2002 method.

In a further embodiment of the invention, the protein-containing composition comprises at most 100 ppm gluten. Preferably, the protein-containing composition comprises at most 50 ppm gluten, more preferably at most 40 ppm gluten, even more preferably at most 30 ppm, and most preferably at most 20 ppm, and preferably at least 10 ppb gluten, more preferably at least 500 ppb, even more preferably at least 1 ppm and most preferably at least 2 ppm. In one embodiment, the protein-containing composition is gluten-free, i.e. the composition comprises less than 20 ppm. Gluten content was determined using AOAC 2012.01.

In one embodiment, the protein-containing composition comprises at least 0.01 wt % crude fiber, more preferably at least 0.1 wt % crude fiber and most preferably at least 0.5 wt % crude fiber, and preferably at most 5 wt % crude fiber, more preferably at most 3 wt % crude fiber and most preferably at most 2 wt % crude fiber, based on the total dry weight of the protein-containing composition. The crude fiber is determined using the ISO 68651:2000 method.

In one embodiment, the protein-containing composition of the invention comprises particles having a d90 value of at most 200 μm. Preferably, the particles have a d90 value of at most 150 μm, preferably at most 125 μm, more preferably at most 100 μm, even more preferably at most 75 μm, even more preferably at most 50 μm, and most preferably at most 40 μm, and at least 1 μm, preferably at least 2 μm, more preferably at least 5 μm and most preferably at least 10 μm.

In a further embodiment, the protein-containing composition comprises at most 10 wt % water. Preferably, the protein-containing composition comprises at most 9 wt % of water, more preferably at most 8 wt %, even more preferably at most 7 wt % and most preferably at most 5 wt %, and preferably at least 0.001 wt %, more preferably at least 0.01 wt % and most preferably at least 0.1 wt %, based on the total dry weight of the protein-containing composition.

The amounts of protein, fiber, lignin, fat and the other components add up to 100% by weight of the protein-containing composition.

The invention further pertains to a mixture comprising the fine fiber composition according to the invention and the protein-containing composition according to the invention.

In one embodiment, the mixture comprises the fine fiber composition and the protein-containing composition in a weight ratio of at least 0.01, preferably at least 0.1 and most preferably at least 0.5, and preferably at most 100, more preferably at most 10, even more preferably at most 5.

The invention further pertains to a mixture comprising the fine fiber composition according to the invention and the coarse fiber composition according to the invention.

In one embodiment, the mixture comprises the fine fiber composition and the coarse fiber composition in a weight ratio of at least 0.01, preferably at least 0.1 and most preferably at least 0.5, and preferably at most 100, more preferably at most 10, even more preferably at most 5.

The invention further pertains to a mixture comprising the coarse fiber composition according to the invention and the protein-containing composition according to the invention.

In one embodiment, the mixture comprises the coarse fiber composition and the protein-containing composition in a weight ratio of at least 0.01, preferably at least 0.1 and most preferably at least 0.5, and preferably at most 100, more preferably at most 10, even more preferably at most 5.

### The Method of Processing the Cereal Spent Grain

The invention further relates to a method for processing cereal grains, preferably brewer's spent grain, characterized in that the method comprises the steps of:
i) optionally washing the cereal grain, whereby protein is separated from the cereal grains to obtain a first protein-containing liquid (22) and the cereal grain;
ii) optionally removing water from the cereal grain to obtain a cereal grain suspension (2) containing 1 to 30% by weight of the cereal grain, based on the total weight of the suspension, and obtaining a second protein-containing liquid (23); and
iii) treating the suspension of cereal grains (2) containing 1 to 30% by weight of the cereal grain with a high shear mill (3) to at least partially release protein encapsulated in the aleurone cells, and to obtain a ground cereal grain fiber (4).

Due to the combination of the appropriate amount of water and the use of a high shear mill, a shear stress can be applied to the spent grain that is sufficient to mechanically open the cell walls of the aleurone cells. In such cell walls protein is captured, which upon opening can be separated from the fibers. In this way a higher protein yield is obtained. Moreover, a coarse fiber fraction can be obtained with a lower protein content, in particular to a content below 15 wt % protein or much less. Microscopic images of the fibers reveal more opened aleurone cells in the aleurone layer and/or cells in which the protein is absent. The inventors further found that mills with which such high shears cannot be reached the opening of the aleurone cells in the aleurone layer and/or an improved protein yield cannot be reached. Examples of such unsuitable mills include roll mills and pin mils. Suitable examples of such mills include hammer mills and meat emulsifiers. In one preferred embodiment, the high shear mill is a hammer mill. In another preferred embodiment, the high shear mill is a meat emulsifier. The term “meat emulsifier” is well known in the art and generally represents meat cutting machines that are capable of cutting meat at high speed and at high shear. Another advantage of this method is that the use of added chemicals is not necessary, which can adversely affect the structure of the recovered protein and/or the fibers.

The invention further relates to a method for processing cereal grain, preferably brewer's spent grain, characterized in that the method comprises the following steps:
i) optionally washing the cereal grains, whereby protein is separated from the cereal grain and a protein-containing liquid and a cereal grain fraction are obtained;
ii) optionally removing water from the cereal grain fraction to obtain a cereal grain suspension having a dry matter content between 1 and 30% by weight cereal grain;
iii) treating the slurry of cereal grain having a solids content between 1 and 30% by weight cereal grains with a hammer mill (3) to release the bound and encapsulated fraction of protein from the fibers, and a ground cereal grains is obtained.

An advantage of the inventive method is that the protein fraction bound and encapsulated in the aleurone layers of the cereal grain is released. Additionally, the fine fiber fraction is also released from the aleurone layer by hammer milling the cereal grain slurry.

In optional step (i) of the inventive method, the cereal grain, preferably brewer's spent grain, is washed whereby protein is separated from the cereal grain, preferably brewer's spent grain, to obtain a first protein-containing liquid (22) and the cereal grain, preferably brewer's spent grain. This washing step can be performed using a solvent in which the free proteins can be dissolved and/or dispersed in order to remove the free protein from the cereal grain. A preferred solvent is water. The presence of free protein in the cereal grain may reduce the efficiency of further processing steps in the inventive method such as the milling step, and therefore it is desirable to remove any free protein. With the term “free protein” is meant the protein present in the cereal grain that can be separated from the fiber and which is not encapsulated in an aleurone cell. The washing step can further be performed on a filter to remove the additional water with free protein from the cereal grain without significantly altering the amount of solvent and/or water present in the original cereal grain.

In one embodiment, the temperature of the suspension in step (i) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In optional step (ii) of the inventive method, water and/or solvent is removed from the cereal grain of step (i), preferably brewer's spent grain, to obtain a cereal grain suspension (2) containing 1 to 30% by weight of the cereal grain, based on the total weight of the suspension, and obtaining a second protein-containing liquid (23). When the cereal grain comprises more than 99 wt % of water, e.g. after a washing step as in step (i) of the inventive method, water is to be removed using any conventional means known in the art. Such conventional means include filters, vacuum filters, decantation and rotary sieves. In one embodiment, this step (ii) may also comprise a step of removing water to a level below 70 wt % of water, after which fresh water can be added to obtain a suspension of the cereal grain with a solids content of from 1 to 30 wt %, which can then be suitably used in step (iii) of the inventive method.

In one embodiment, the temperature of the suspension in step (ii) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In step (iii) of the inventive method, the suspension of the cereal grain (2) containing 1 to 30% by weight of the cereal grain is treated with a high shear mill (3) to at least partially release protein encapsulated in the aleurone cells, and to obtain a ground cereal grain fiber (4). The inventory have found that milling a suspension having a solids content between 1 and 30% by weight of the suspension using a high shear mill is effective and capable of opening aleurone cells and releasing protein from the aleurone layer. When the suspension has less than 1 wt % of solids of the aleurone-containing plant-based material, the high shear milling will not be effective and/or economically feasible. When the suspension has more than 30 wt % of solids, the suspension is generally too thick or viscous for a commercially interesting productivity and moreover the effectiveness of the shear applied to the plant-based material is insufficient.

In one embodiment, the high shear mill is a hammer mill. The hammer mill can be any hammer mill known in the art. The hammer mill can be operated at a high shear necessary to opening the aleurone cells; such a high shear can be obtained by the appropriate settings of the screen mesh size, distance of the hammer(s) to the screen and the rotational speed of the hammer(s). Determining whether sufficient shear is applied can be carried out by assessing the number of empty cells in the milled cereal grain, in particular in the coarse fiber composition obtained. Sufficient shear is applied when the percentage of empty aleurone cells increases compared to the percentage of empty aleurone cells in the untreated cereal grain, preferably brewer's spent grain.

In one embodiment, the mesh size of the screen is at most 5 mm, preferably at most 2 mm and most preferably at most 1 mm, and preferably at least 100 μm, more preferably at least 200 μm, and most preferably at least 500 μm.

In one embodiment, the distance of the hammer(s) to the screen is at most 5 mm, preferably at most 2 mm and most preferably at most 1 mm, and preferably at least 100 μm, more preferably at least 200 μm, and most preferably at least 500 μm.

In another embodiment, the rotational speed of hammer(s) is at least 2,500 rpm, preferably at least 5,000 rpm and most preferably at least 10,000 rpm and preferably at most 60,000 rpm, more preferably at most 50,000 rpm and most preferably at most 40,000 rpm.

In one embodiment, the high shear mill is a meat emulsifier. The meat emulsifier can be any meat emulsifier known in the art. The meat emulsifier can be operated at a high shear necessary to opening the aleurone cells; such a high shear can be obtained the appropriate settings of the screen, distance of the knives to the screen mesh size and the rotational speed of the knives. Determining whether sufficient shear is applied can be carried out by assessing the number of empty cells in the milled cereal grain, in particular in the coarse fiber composition obtained. Sufficient shear is applied when the percentage of empty aleurone cells increases compared to the percentage of empty aleurone cells in the untreated cereal grain, preferably brewer's spent grain.

In one embodiment, the mesh size of the screen is at most 5 mm, preferably at most 2 mm and most preferably at most 1 mm, and preferably at least 100 μm, more preferably at least 200 μm, and most preferably at least 500 μm.

In one embodiment, the distance of the knives to the screen is at most 3 mm, preferably at most 2 mm and most preferably at most 1 mm, and preferably at least 350 μm, more preferably at least 400 μm, and most preferably at least 500 μm.

In another embodiment, the rotational speed of the knives) is at least 1,000 rpm, preferably at least 1,500 rpm and most preferably at least 2,000 rpm and preferably at most 20,000 rpm, more preferably at most 10,000 rpm and most preferably at most 5,000 rpm.

In one embodiment, the temperature of the suspension in step (iii) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C. The temperature is chosen such that the aleurone cells can be opened more easily and the microbes do not grow or grow very slowly.

The invention further pertains to the product obtained or obtainable by the above inventive process. The ground cereal grain fiber (4) is considered to be the coarse fiber composition of the invention except that the composition comprises a higher protein content compared to the coarse fiber composition obtained in step (v). Moreover, the first and second protein-containing liquids are considered to be protein-containing composition in accordance with the invention, except that the overall protein yield is relatively low compared to the protein-containing composition obtained in step (vi).

In one embodiment of the invention, the ground cereal grain can subsequently be sieved and/or washed in a rotary sieve, a centrifugal sieve or other sieve with a mesh size of 50 to 250 μm and operated at ambient or increased pressure, to separate the fiber fraction from the protein-containing fraction, washing the cereal grains with recycled water can become.

It is clear that instead of recycled water, tap and/or demineralized water can also be used for washing the cereal grains.

Subsequently, the step of pressing the fiber fraction may take place in a screw press or a chamber filter press to reduce the water content of the fiber fraction.

In one embodiment of the invention, the method further comprising the steps of:
(iv) separating the ground cereal grain fiber (4) in a rotary sieve (5) or a centrifugal sieve (5′) from the third protein-containing liquid (8) whereby the ground cereal grain fiber is sprayed with water;
(v) removing water from the ground fiber (7) in a press, preferably in a screw press (9) or a chamber filter press (9′), to obtain a coarse fiber composition and a fourth protein-containing liquid (10), and optionally drying the coarse fiber composition; and
(vi) combining the first, second, third and/or fourth protein-containing liquids to form one protein-containing liquid (12) and separating the protein from water to obtain a protein-containing composition, and optionally drying the protein-containing composition.

In a preferred embodiment, the method further comprises the following steps:
(iv) the ground cereal grains are sieved in a rotary sieve (5) or centrifugal sieve to separate the fiber fraction (7) from the protein-containing water (8) whereby the cereal grains are sprayed with water;
(v) the aforesaid fiber fraction (7) is pressed, preferably in a screw press (9) or a chamber filter press (9′), to reduce the water content of the fiber fraction (7) and increase the dry matter content, whereby a coarse fiber composition is obtained and a protein-containing water stream (8);
(vi) the protein-containing water (8) from the rotary screen (5) and the water stream (10) from the screw press (9) or chamber filter press (9′) are combined and mixed in a mixer (11) to form a protein-containing water stream (12) to subsequently settle to further separate the concentrated protein fraction into water and protein.

In step (iv) of the inventive method, the ground cereal grain fiber (4) is separated in a rotary sieve (5) or a centrifugal sieve (5′) from the third protein-containing liquid (8) whereby the ground cereal grain fiber is sprayed with water.

In one embodiment, the ground cereal grain fiber (4) is separated from the third protein-containing liquid using a rotary sieve. The rotary sieve can be any rotary sieve known in the art and suitable for separating such ground cereal grain from liquid. In one embodiment, the mesh size of the sieve is at most 500 μm, preferably at most 300 μm and most preferably at most 200 μm, and preferably at least 10 μm, more preferably at least 20 μm, and most preferably at least 50 μm. preferably at least 10 μm, more preferably at least 20 μm, and most preferably at least 50 μm. The rotary sieve can be operated at ambient or increased pressure. Preferably, the rotary sieve is operated at increased pressure.

In one embodiment, the ground cereal grain is separated from the third protein-containing liquid using a centrifugal sieve. The centrifugal sieve can be any centrifugal sieve known in the art and suitable for separating such ground cereal grain from liquid. In one embodiment, the mesh size of the sieve is at most 500 μm, preferably at most 300 μm and most preferably at most 200 μm, and preferably at least 10 μm, more preferably at least 20 μm, and most preferably at least 50 μm. The centrifugal sieve can be operated at ambient or increased pressure. Preferably, the centrifugal sieve is operated at increased pressure.

It is envisaged to use a plurality of rotary sieves and centrifugal sieves or a combination of at least one rotary sieve and at least one centrifugal sieve.

In one embodiment of the invention, the ground cereal grain fiber is sprayed with water. This water is added to increase the separation efficiency of the rotary or centrifugal sieve.

In one embodiment, the temperature of the suspension in step (iv) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In step (v) of the inventive method, water is removed from the ground fiber (7) in a press, preferably in a screw press (9) or a chamber filter press (9′), to obtain a coarse fiber composition and a fourth protein-containing liquid (10), and optionally drying the coarse fiber composition.

In one embodiment, water is removed from the ground cereal grain fiber using a screw press. The screw press can be any screw press known in the art and suitable for removing water from such ground cereal grain fiber. In one embodiment, the mesh size of the screen is at most 300 μm, preferably at most 200 μm and most preferably at most 100 μm, and preferably at least 10 μm, more preferably at least 20 μm, and most preferably at least 50 μm.

In one embodiment, water is removed from the ground cereal grain fiber using a chamber filter press. The chamber filter press can be any chamber filter press known in the art and suitable for removing water from such ground cereal grain fiber. In one embodiment, the mesh size of the filter in the chamber filter press is at most 300 μm, preferably at most 200 μm and most preferably at most 100 μm, and preferably at least 10 μm, more preferably at least 20 μm, and most preferably at least 50 μm.

It is envisaged to use a plurality of chamber filter presses and screw presses or a combination of at least one chamber filter press and at least one screw press.

In one embodiment, the temperature of the suspension in step (v) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In step (v) of the inventive method, a coarse fiber composition is obtained. In one embodiment, the coarse fiber composition is dried. The drying method can be any drying method known in the art. Suitable drying methods include oven drying, flash drying, spray drying and fluidized bed drying.

In step (vi) of the inventive method, the first, second, third and/or fourth protein-containing liquids are combined to form one protein-containing liquid (12) and the protein is separated from water to obtain a protein-containing composition, and optionally drying the protein-containing composition.

In step (vi) the first, second, third and/or fourth protein-containing liquids are combined together and preferably mixed in a mixer (11). When steps (i) and (ii) are omitted, the third and fourth protein-containing liquids are combined and preferably mixed in a mixer (11). The mixer can be any mixer known in the art. Subsequently, the protein is separated from water using any conventional means including decantation and filtering. Preferably, protein and water are separated by decantation in a decanter unit (16).

In one embodiment, the temperature of the suspension in step (vi) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In step (vi) of the inventive method, a protein-containing composition is obtained. In one embodiment, the protein-containing composition is dried. The drying method can be any drying method known in the art. Suitable drying methods include oven drying, flash drying, spray drying and fluidized bed drying.

In one embodiment, the water flow from the rotary screen and the water flow from the screw press or chamber filter press can be combined and mixed to form a protein-containing water stream.

This protein-containing water stream can then be separated into an undissolved fiber fraction, purified protein-containing water stream, and a fiber fraction with a low nitrogen content in a hydrocyclone to the skill of the person skilled in the art, and the skilled person can, at his own discretion and appropriate conditions can be set.

In a preferred embodiment, the invention relates to obtaining a fine fiber composition, characterized in that the protein-containing water stream (8) is separated into a purified protein-containing water stream (14), and a fine fiber composition (15) by centrifugation, preferably in a hydrocyclone (13), and/or by filtration.

In a further preferred embodiment, the invention relates to obtaining a protein-containing composition, characterized in that the purified protein-containing water stream (14) is separated into a supernatant (18) by centrifugation in a decanter unit (16) and protein-containing composition (17) which is separated and optionally the supernatant (18) is recycled in the cereal grain feed, in the washing drum and in the hammer mill; and optionally after separating off the protein-containing composition (17), in a next step the separated protein-containing particles (17) are dried.

From the protein-containing water stream, protein-containing particles can be separated, preferably by means of centrifugation in a decanter unit.

The protein-containing water stream may first undergo a thickening step before centrifugation, in which the protein-containing water is retained for some time for sedimentation of the protein-containing particles, after which it is preferably pumped from below towards the decanter unit for further treatment.

In this case, the decanter unit yields two products, being protein-poor water and protein concentrate.

The water fraction can be recycled at the cereal grain entrance, at the washing drums and optionally at the hammer mill to use the correct water content in the grind.

Finally, the separated protein-containing particles are preferably dried, for example in a drying installation.

The separated protein-containing particles form a protein-containing composition. Such drying equipment is preferably a rotary flash dryer which preferably dries at a temperature below 70° C. and a preferred drying time of 2 to 10 seconds, in order to preserve the chemical and physical properties such as for example for rehydration, after which the protein yield is 50 to 75 wt % of the dry matter.

However, the drying of the separated protein-containing particles can be realized in different ways and by means of various drying installations, as long as after drying the separated protein-containing particles can be re-suspended in water or other solvent.

The dried concentrate comprises relatively high amount of protein and has the physical property of being spreadable. The use of a flash dryer leads to a higher water absorption in the protein concentrate, so that the concentrate can be used as feed for fish farming, animal feed, animal feed and also as food for human consumption due to its water retention capacity as a soy substitute in vegetarian products such as meat substitutes.

An advantage of this protein concentrate is that its physical properties and the presence of unsaturated fatty acids allow the concentrate to be used as a food.

Another advantage of this protein concentrate is that unexpectedly approximately 30% of the fibers that went through the filtration process are smaller than 60 micrometers, which fibers have special properties that make them suitable as healthy dietary fibers in human nutrition and make an important contribution to a healthy intestinal flora.

These smaller fibers obtained after the filtration process are also referred to in the present description as the fine fiber composition. Furthermore, protein concentrate is also referred to as the above-described protein-containing composition.

The protein concentrate can also be used in extrusion technology.

An additional advantage of this method is that the entire process uses the water that comes from the cereal grain itself and that starting water is only needed at start-up. The relatively large water flow is recycled as much as possible to recover the protein present and use it as a food product.

The remaining dry fiber fraction can be valorized as short cycle fuel for a biomass combustion plant, preferably with staged temperature zones. The low nitrogen content, less than 15 wt % total protein in the fiber or lower, allows this fiber fraction to be used as an environmentally friendly fuel for heating a beer brewery, for example, or for a total energy supply through combustion and electricity generation.

Another advantage of the inventive method is that the device for applying the method does not necessarily have to be located at a fixed location, such as the brewery, but can also be used at other locations, and can even be moved to, for example, storage locations of organic residual flows to be processed that similar to cereal grains.

The dry fiber fraction, both the coarse and the fine fiber composition according to the invention, can also find its way as a nutritious source of fibers consisting of hemicellulose, cellulose, lignin, glucans and xylans and can be used as an additive in animal feed, animal feed or in human food.

In a first variant embodiment of the inventive method, the cereal grains first undergo a pre-washing in a rotating sieve, to subsequently obtain a reduced water content again in a pre-pressing in a screw press, before being fed to the hammer mill and further treated as in the inventive method, to rid the fibers of residual protein.

In this first variant embodiment, the wash water from the pre-wash in a first rotary screen and the press water from the first screw press are also fed to the mixer, in which protein-containing water is combined before being further fractionated in the hydrocyclone.

In a second variant embodiment of the inventive method, an additional filtering step is interposed by means of a cyclone filter, between the hydrocyclone and the decanter unit.

The fiber fraction recovered from the decanter unit still comprises an amount of protein of 150-260 g/kg dry matter, which can be further recovered by an additional process in a reactor.

The invention further pertains to a method further comprising the step of:
(vii) centrifuging and filtering the protein-containing liquid (12) to obtain a fine fiber composition (15) and a protein-containing composition (17), and optionally drying compositions (15) and/or (17) separately.

In step (vii), the protein-containing liquid (12) obtained in step (vi) is further fractionated by centrifugation and filtering into a protein-containing composition and a fine fiber composition. The fine fiber composition comprises of fine fibers of the cereal grain that are small enough to pass the press and filters together with the proteins. Preferably, the centrifugation and filtering are performed using a cyclone filter such as a hydrocyclone (13). The cyclone filter can be any cyclone filter known in the art and capable of separating fine fibers and protein. Preferably, the cyclone filter is a hydrocyclone.

In one embodiment, the temperature of the suspension in step (vii) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In step (vii) of the inventive method, a fine fiber composition is obtained. In one embodiment, the fine fiber composition is dried. The drying method can be any drying method known in the art. Suitable drying methods include oven drying, flash drying, spray drying and fluidized bed drying.

In step (vii) of the inventive method, a protein-containing composition is obtained. In one embodiment, the protein-containing composition is dried. The drying method can be any drying method known in the art. Suitable drying methods include oven drying, flash drying, spray drying and fluidized bed drying.

In a third variant embodiment, an additional process is added in a reactor, which process is an enzymatic process.

In a fourth variant embodiment, an additional process is also added in a reactor, which process is now a chemical process.

Both additional processes in a reactor are aimed at releasing additional protein that is still in the aleurone layer of the cereal grains.

The invention further pertains to a method further comprising the step of:
(viii) contacting and incubating a suspension of the coarse fiber composition (30) of step
(v) comprising 1 to 30% by weight of ground cereal grain with an enzyme capable of hydrolyzing the aleurone cell wall to obtain an enzyme-treated fiber fraction;
(ix) optionally separating the enzyme-treated fiber fraction in a rotary sieve (5′) or centrifugal sieve from the fifth protein-containing liquid (8′) whereby the enzyme-treated fiber fraction is sprayed with water; and
(x) optionally removing water from the enzyme-treated fiber fraction, preferably in a screw press (9′) or a chamber filter press (not shown), to obtain a coarse fiber composition and a sixth protein-containing liquid (10); and
(xi) combining the fifth and sixth protein-containing liquids, optionally with the first, second, third and/or fourth protein-containing liquids, to form one protein-containing liquid (12′) and separating the protein from water to obtain a protein-containing composition, and optionally drying the protein-containing composition.

The invention further pertains to a method for producing a coarse fiber composition from cereal grain, preferably from Brewer's spent grain, comprising the steps of:
(i) contacting and incubating a suspension of the fiber composition comprising coarse fibers of cereal grains, characterized in that the coarse fiber composition comprises at least 65 wt % (wt %) insoluble high molecular weight dietary fibers (insoluble HMWDF) and less than 15 wt % protein, based on the total dry weight of the coarse fiber composition, comprising 1 to 30% by weight of the coarse fiber composition with an enzyme capable of hydrolyzing the aleurone cell wall to obtain an enzyme-treated fiber fraction;
(ii) optionally separating the enzyme-treated fiber fraction in a rotary sieve (5′) or centrifugal sieve from the fifth protein-containing liquid (8′) whereby the enzyme-treated fiber fraction is sprayed with water;
(iii) optionally removing water from the enzyme-treated fiber fraction, preferably in a screw press (9′) or a chamber filter press (not shown), to obtain a coarse fiber composition and a sixth protein-containing liquid (10); and
(iv) combining the fifth and sixth protein-containing liquids, optionally with the first, second, third and/or fourth protein-containing liquids, to form one protein-containing liquid (12′) and separating the protein from water to obtain a protein-containing composition, and optionally drying the protein-containing composition.

The enzymatic hydrolysis of aleurone cell wall material is more effective on coarse fibers with a relatively low protein content and/or a low amount of free protein. With the term “free protein” is meant the protein that can be separated from the fiber and which is not encapsulated in an aleurone cell. The inventors have found that the presence of free protein reduces the enzymatic activity significantly, which is generally detrimental to the economic feasibility of the process. It is therefore advantageous to treat the coarse fiber composition with a low protein content and/or obtained with the above-identified method with the enzyme. With this enzymatic process the total amount of protein, and in particular the amount of nitrogen, can be considerably reduced, even to levels below 6 wt % protein, based on the total dry weight of the coarse fiber composition. Moreover, the yield of protein is increased as the protein-containing water stream obtained in this enzymatic process can be mixed with the protein-containing water streams obtained elsewhere in the process and processed as indicated above to obtain the protein-containing composition of the invention.

With the wording “enzyme capable of hydrolyzing the aleurone cell wall” is meant enzyme or a combination of enzymes that can hydrolyze oligomers and/or polymers present in the aleurone cell wall. Examples of such oligomers and/or polymers include cellulose, hemicellulose, arabinoxylans and ferulic acid. Such enzymes are generally not capable of hydrolyzing proteins and/or peptides. In other words, the proteins will remain unaffected during the enzymatic process of the invention. Examples of suitable enzymes include a cellulase, a hemicellulase, a xylanase, a glucanase and combinations thereof. Preferably, the enzyme is selected from a cellulase, a hemicellulose, a xylanase and combinations thereof. Most preferably, the enzyme is a cellulase. In one embodiment, the enzyme comprises a cellulase and a xylanase. In a further embodiment, the enzyme comprises a cellulase and a hemicellulase. In yet a further embodiment, the enzyme comprises a hemicellulase and a xylanase. In one embodiment, the enzyme comprises a cellulase and a glucanase.

In one embodiment of the invention, the amount of enzyme in the process is at least 0.05 wt % enzyme, based on the total dry weight of the coarse fiber composition (i.e. 0.5 g/kg fiber composition used in the process). Preferably, at least 0.1 wt % enzyme, more preferably at least 0.15 wt % enzyme, and most preferably at least 0.2 wt % enzyme, and preferably at most 10 wt % enzyme, more preferably at most 8 wt % enzyme, even more preferably at most 6 wt % and most preferably at most 5 wt %, based on the total dry weight of the coarse fiber composition. With “total weight of the coarse fiber composition” is meant the dry weight of the coarse fiber composition as presented in step (vii) or step (i) in the processes described above.

In a further embodiment, the suspension in the process comprises at least 1 wt % of coarse fiber composition, based on the total weight of the suspension. Preferably, the suspension comprises at least 2 wt % of coarse fiber composition, more preferably at least 5 wt % of coarse fiber composition, and preferably at most 30 wt % of coarse fiber composition, more preferably at most 25 wt % of coarse fiber composition, and most preferably at most 20 wt % of coarse fiber composition, based on the total weight of the suspension.

In one embodiment, the temperature of the suspension is at least 20° C., preferably at least 30° C., more preferably at least 40° C. and most preferably at least 50° C., and preferably at most 90° C., more preferably at most 80° C. and most preferably at most 70° C. During step (vii) or step (i) of the processes described above, the temperature may be brought to the desired temperature before, during or after adding the enzyme to the suspension. Preferably, the enzyme is added after the desired temperature is reached.

In one embodiment, the incubation time is at least 1 hour, preferably at least 2 hours, more preferably at least 5 hours and most preferably at least 10 hours, and preferably at most 48 hours, more preferably at most 36 hours and most preferably at most 24 hours. The incubation time is generally determined by the desired protein reduction.

The specific embodiments of the remaining steps in the inventive processes have been described above for the non-enzymatic processes, and also apply to the enzymatic processes.

In step (x) of the inventive method, a coarse fiber composition is obtained. In one embodiment, the coarse fiber composition is dried. The drying method can be any drying method known in the art. Suitable drying methods include oven drying, flash drying, spray drying and fluidized bed drying.

In step (xi) of the inventive method, a protein-containing composition is obtained. In one embodiment, the protein-containing composition is dried. The drying method can be any drying method known in the art. Suitable drying methods include oven drying, flash drying, spray drying and fluidized bed drying.

The invention further pertains to a method further comprising the step of:
(xii) centrifuging and filtering the protein-containing liquid (12′) to obtain a fine fiber composition (27′) and a protein-containing composition (28′), and optionally drying compositions (27′) and/or (28′) separately.

In step (xii), the protein-containing liquid (12′) obtained in step (xi) is further fractionated by centrifugation and filtering into a protein-containing composition and a fine fiber composition. The fine fiber composition comprises of fine fibers of the cereal grain that are small enough to pass the press and filters together with the proteins. Preferably, the centrifugation and filtering are performed using a cyclone filter such as a hydrocyclone (13). The cyclone filter can be any cyclone filter known in the art and capable of separating fine fibers and protein. Preferably, the cyclone filter is a hydrocyclone.

In one embodiment, the temperature of the suspension in step (xii) is maintained at a temperature above room temperature. Preferably, the temperature of the suspension is at least 25° C., more preferably at least 30° C., more preferably at least 35° C. and most preferably at least 40° C., and preferably at most 80° C., more preferably at most 75° C., and most preferably at most 70° C.

In step (xii) of the inventive method, a fine fiber composition is obtained. In one embodiment, the fine fiber composition is dried. The drying method can be any drying method known in the art. Suitable drying methods include oven drying, flash drying, spray drying and fluidized bed drying.

In step (xii) of the inventive method, a protein-containing composition is obtained. In one embodiment, the protein-containing composition is dried. The drying method can be any drying method known in the art. Suitable drying methods include oven drying, flash drying, spray drying and fluidized bed drying.

In one embodiment of the invention, the cereal grain is brewer's spent grain.

The invention also relates to a device for applying the inventive method and/or alternative method as described above, wherein the hammer mill, the rotary screen, the screw press or chamber filter, the mixer, the hydrocyclone and the decanter unit are coupled to each other in such a way that they enable a continuous or semi-continuous process for the recovery of high-quality protein concentrate and low-nitrogen fibers from cereal grains.

The invention also relates to devices for applying the second, third and fourth variant embodiments.

The remaining nitrogen-poor fibers from cereal grains can be used as a fiber-rich additive in human food, animal feed or animal feed.

The remaining nitrogen-poor fibers from cereal grains can also be used as short-cycle biomass for renewable energy generation or can be processed into pellets for delayed combustion.

The aforementioned compositions can be obtained from the above-described method.

It is clear that the aforementioned compositions offer the same and/or additional advantages as the aforementioned method.

In order to better demonstrate the features of the invention, some preferred embodiments of the process for recovering protein-rich concentrate from cereal grain and low-nitrogen fibers according to the invention are described below, as examples without any limiting character, with reference to the accompanying drawings, in which:

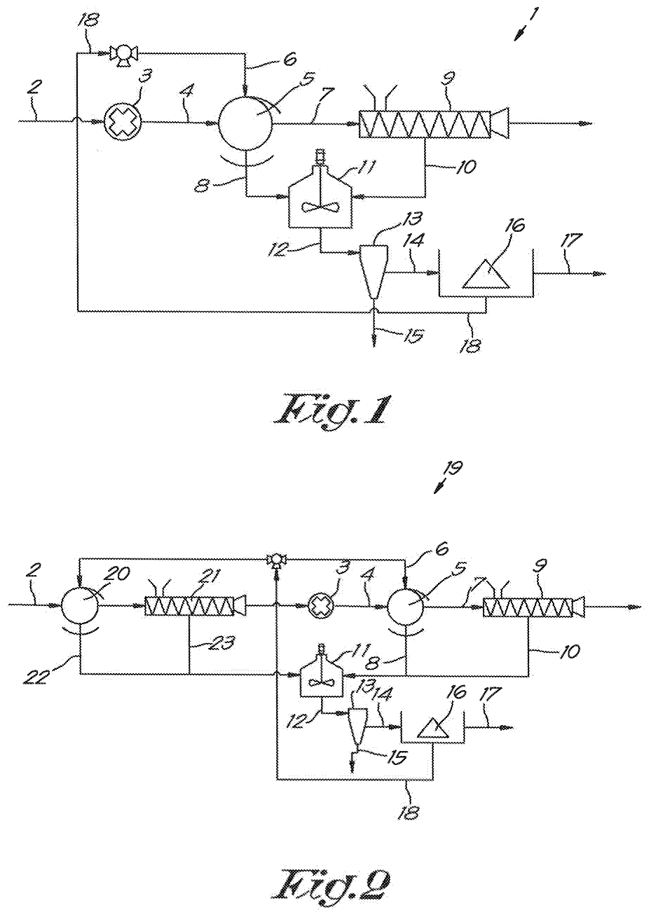

FIG. 1 schematically represents a flow chart for carrying out the inventive method according to the invention;

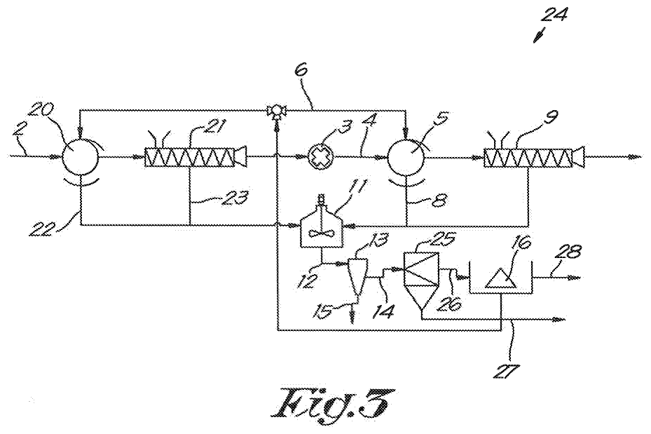

FIG. 2 shows the flow chart of FIG. 1, but now with a pre-treatment in a second rotary screen and a press;

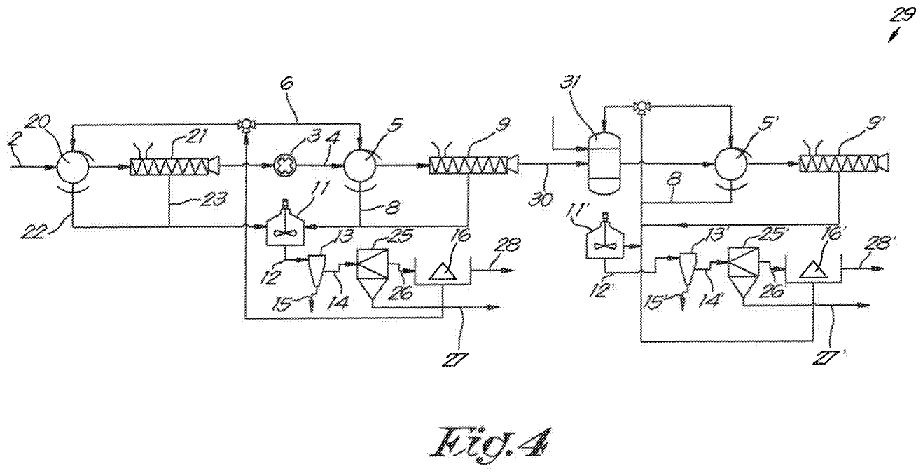

FIG. 3 shows the flow chart of FIG. 2, but now with the addition of a cyclone filter;

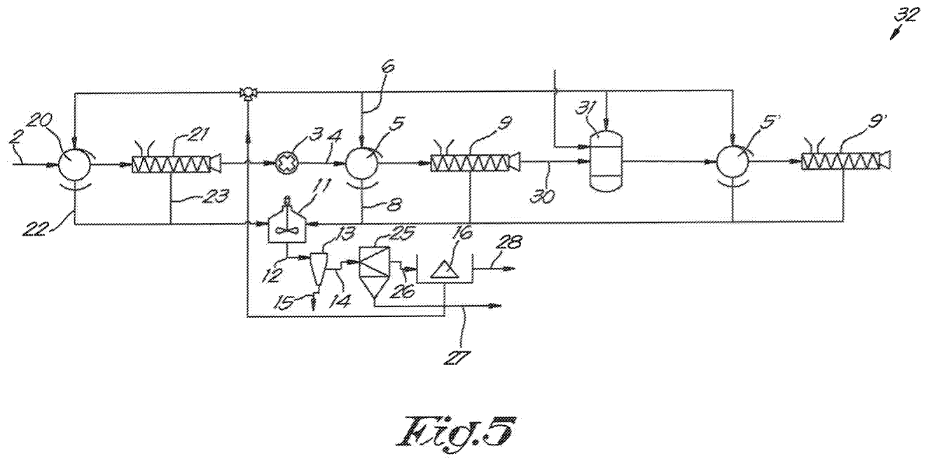

FIG. 4 shows the flow diagram of FIG. 3, but now with the addition of a separate after-treatment in a reactor in a separate circuit;

FIG. 5 shows the flow diagram of FIG. 3, but now with the addition of an after-treatment in a reactor in the same closed circuit.

FIG. 1 schematically shows a flow diagram 1 of an apparatus for applying the inventive method according to the invention for recovering protein-rich concentrate and low-nitrogen fibers from cereal grains, wherein
in a first phase, the cereal grain 2 is supplied and fed into a hammer mill 3 or meat emulsifier (not shown) with an adapted configuration according to the type of cereal grain and its dry matter content in terms of filter mesh size, blade sharpness and rotational speed;
in a second phase, the crushed and scraped mixture 4 obtained from the first phase can be sieved in a rotary sieve 5 which is sprayed with water 6 to separate the fiber fraction 7 from the protein-containing water 8;
preferably in a next stage the fiber fraction 7 is dewatered by being pressed in press 9, which can be a screw press or a chamber filter press, after which the protein-containing water 8 from the rotary screen 5 and the water stream 10 from the press are combined and mixed in a mixer 11 into one protein-containing water stream 12, which water stream 12,
can then be separated in a subsequent phase by means of a hydrocyclone 13 into a 90-100% of undissolved fibers, purified protein-containing water stream 14, and a pure fiber fraction 15 with a low nitrogen content, after which the protein-containing water stream 14,
can then be separated in a subsequent stage by centrifugation in a decanter unit 16 into a stream of suspended protein-containing particles 17 and a supernatant 18 which is recycled in the cereal grain feed, from the washing drum and from the hammer mill.

When processing the cereal grains with the hammer mill, the cereal grains are in suspension with a solids content between 1 and 30% by weight cereal grains.

During its processing with the hammer mill, the cereal grain in suspension preferably comprises at least a solids content of 2 wt % cereal grains, more preferably at least 5 wt % cereal grains and a maximum of 17 wt % cereal grains, more preferably a maximum of 15 wt % cereal grains relative to the total weight of the suspension.

This allows the hammer mill to generate the desired shear stress, so that the aleurone and endosperm layers can be broken better and thus protein can be released from these layers, resulting in a higher yield of proteins from these layers in absolute terms.

It is noted here that processing the dry grain or brewer's grains by means of the hammer mill does not lead to the opening of the aleurone and endosperm layer of the cereal grains.

In addition to brewer's grains, other co-products can also be used, which originate, for example, from a beer brewing process. Likewise, trub can be processed by the method described above, wherein the trub is preferably added after processing the cereal grain in suspension with a hammer mill.

This is not necessary, however, it is also possible to add the trub in a later step of the method according to the invention.

Trub here refers to the solid particles in wort, such as flocculated proteins and hop cones, which are removed by sieving or filtering the wort in a whirlpool or hop back.

Additionally, it is also possible to process the trub by the aforementioned method without using grain or cereal grain in suspension during the processing of the trub.

The pure fiber fraction with a low nitrogen content, also referred to as coarse fiber composition, is discharged for processing into reusable material or for use as short-cycle biomass for the generation of sustainable energy.

This pure fiber fraction 15 is a dry fiber fraction and is said fine fiber composition.

The stream of suspended protein-containing particles 17 in this case is the aforementioned protein-containing composition.

Alternatively, after the first phase, chemicals, for example enzymes, can also be used for the post-treatment of the ground cereal grains. This treatment makes it possible to release even more protein from the grain or brewer's grains, resulting in a higher protein yield and a coarse fiber composition with a lower nitrogen (or protein) content.

FIG. 2 shows schematically a flow diagram 19 of a first variant device in which the cereal grain 2 first undergoes a pre-washing in a rotating sieve 20, after which it undergoes a pre-pressing in a press 21, before being fed to the hammer mill 3 and further treated. as in the embodiment of FIG. 1 to rid the fibers of residual protein. In this first variant device, the washing water 22 from the pre-wash in a first rotating screen 20 and the press water 23 from the first press 21 are fed to the mixer 11, in which protein-containing water is combined before being further fractionated in the hydrocyclone 13 as in the embodiment of FIG. 1.

FIG. 3 shows schematically a flow diagram 24 of a second variant device in which the cereal grain 2 is treated as described in FIG. 2, but now with an additional filtering step in a cyclone filter 25, between the hydrocyclone 13 and the decanter unit 16.

FIG. 4 shows schematically a flow diagram 29 of a third variant device in which the cereal grain 2 is treated as described in FIG. 3, but is now followed by a separate post-treatment of the fiber fraction 30 in a reactor 31 with an enzymatic process.

The fiber fraction 30 coming from the second press 9 of the process of FIG. 3 is hereby fed to a separate reactor 31, in which this fraction is incubated with cellulase and xylanase enzymes, preferably at a pH<6 and a temperature of 30-60° C. After an incubation under optimal conditions, the remaining fibers are washed and pressed as in the second variant device of FIG. 3, and also further processed as in FIG. 3, but in a separate device with a rotary dryer 5′, a press 9′, a mixing vessel 11′, a hydrocyclone 13′, a cyclone filter 25′, and a decanter unit 16′.

The resulting fiber fraction 28′ has a residual protein content of less than 50 g/kg dry matter. The additionally recovered protein from cereal grains is used as press water and washing water and processed into the same protein product 28′.

FIG. 5 shows schematically a flow diagram 32 of a fourth variant device in which the cereal grain 2 is treated as shown in FIG. 3, but is now followed in a closed cycle by an integrated after-treatment in a reactor with a chemical process.

The fiber fraction 30 coming from the second press 9 of the process of FIG. 3 is herein fed to a separate reactor 31, in which this fraction is brought to a pH of 9 to preferably pH 10.5 with an alkaline salt and at a temperature is brought to between 2° and 100° C. Preferably, the temperature is higher to shorten the reaction time.

After completion of the chemical reaction, the remaining fiber fraction is washed and pressed as shown in the process of FIG. 3, and passed on to the one already present loop with mixing vessel 11, hydrocyclone 13, cyclone filter 25, and decanter unit 16, producing additional recovered protein 28 from cereal grain.

The inventive method and variant methods according to the invention are simple and allow to process the remaining cereal grains after the production of beer in a continuous or semi-continuous process by separating the solid fiber fraction from the aqueous protein-containing fraction, whereby none or very few chemicals are added and the separation of the two fractions is achieved exclusively or mainly by mechanical means, resulting in the isolation of a natural high-quality protein concentrate and low-nitrogen fibers.

Still according to the invention, the fine fiber composition and/or the coarse fiber composition and/or protein-containing composition can be used to prepare a mixture comprising two or more of the aforementioned compositions.

The proportions of these compositions in a particular mixture can be adjusted according to the wishes of the customer and/or the end product in which it will be processed.

The fine fiber composition and the coarse fiber composition and protein-containing composition as well as a mixture of 2 or more of these compositions according to the invention can be used in a wide variety of applications.

The invention relates to the use of the one or more of the aforementioned compositions and/or mixtures thereof in food applications, paints, construction applications, paper and paper products, textiles, e.g. fiber treatment, leather lubrication, home care compositions, softening, textile care in laundry applications, health care applications, release agents, water based coatings, personal care or cosmetic applications, emulsion polymerizations, floor coverings, automotive parts, window frames, kitchen countertops, container closures, lunch boxes, closures, medical devices, household goods, food containers, dishwashers, outdoor furniture, blown bottles, disposable non-woven fabrics, cables and wires, packaging, coil coating applications, can coatings, automotive refinish paint, mining, oil drilling, fuel additives and automotive applications.

Each of these uses is considered separately and is intended to be disclosed explicitly and individually.

The invention is further demonstrated in the following examples.

### EXAMPLE 1: METHOD FOR OBTAINING A PROTEIN-CONTAINING COMPOSITION, A COARSE FIBER COMPOSITION AND A FINE FIBER COMPOSITION

Water is added to 2 tons of brewer's grains (BSG) (23.6% by weight of dry matter), and a suspension with 5% by weight of brewer's grains is obtained. The suspension is brought to a temperature of 50° C. and ground in a hammer mill with a sieve with a mesh size of 2 mm. The milled suspension is passed over a rotating sieve with a mesh size of 150 μm at a temperature of 50° C. Water is added during the screening step to wash the fiber fraction. The protein-rich water flow is collected. The fiber-rich fraction is then passed over a screw press at a temperature of 50° C. to remove water from the fibers; a fiber-rich fraction with 45 wt % dry matter is obtained.

The water stream obtained from the screw press is combined with the previously obtained protein-rich water stream (the protein-rich fraction). This protein-rich fraction is passed over a cyclone filter with a mesh size of 100 μm at a temperature of 50° C. to separate fine fibers from a protein-rich retentate, and in this way to reduce the amount of fiber in the protein fraction. The protein-rich fraction is decanted and separated from the fine fiber fraction. The protein-rich fraction is dried in a rotary flash dryer at a temperature of 65° C. with an average residence time of 8 seconds. The fine fiber fraction and the fiber fraction are also dried separately in a rotary flash dryer at a temperature of 65° C. with an average residence time of 8 seconds.

The yield of the dried fractions is about 300 kg of the coarse fiber composition, 32 kg of the fine fiber composition and 137 kg of the protein-containing composition.

### Brewer's Spent Grain

The initial brewer's grain has a total dietary fiber fraction of 52.8 wt %, with an insoluble HMWDF of 50.5 wt % and a soluble HMWDF of 2.3 wt %. These values were measured using the standard method AOAC 2011.25.

The fiber fraction is further characterized by an NDF value of 559 g per kg dry weight, an ADF value of 209 g per kg dry weight and an ADL value of 39 g per kg dry weight. Converted, the protein fraction comprises 17.0 wt % cellulose, 35.0 wt % hemicellulose and 3.9 wt % lignin. The weight ratio of hemicellulose and cellulose is 8.97 and the weight ratio of hemicellulose and lignin is 23.0. The cellulose/lignin weight ratio is 4.36.

The ADF and ADL values were determined according to the standard method NEN-ISO 13906:2008, and the NDF value was determined according to the standard method NEN-ISO 16472:2006.

The brewer's grain further comprises 28.9 wt % protein, 11 wt % fat, 3.6 wt % crude ash and 5.7 wt % water. The protein/fat weight ratio is 2.73. The protein-containing composition comprises 13.6 wt % crude fiber.

The BSG contained 9% of empty aleurone cells, based on the total number of aleurone cells as determined using confocal scanning laser microscopy.

The BSG contained 21.6% of ruptured cells, based on the total number of aleurone cells as determined using scanning electron microscopy. The total number of aleurone cells assessed were 1386. The BSG sample contains both protein-filled aleurone cells and free protein.

### Protein Composition

The dried protein fraction has a total dietary fiber fraction of 23.1 wt %, with an insoluble HMWDF of 19.7 wt % and a soluble HMWDF of 3.4 wt %. These values were also measured here using the standard method AOAC 2011.25.

The protein-containing composition comprises fibers and is further characterized by an NDF value of 157 g per kg dry weight, an ADF value of 42 g per kg dry weight and an ADL value of 5 g per kg dry weight. Converted, the protein fraction comprises 3.7 wt % cellulose, 11.5 wt % hemicellulose and 0.5 wt % lignin. The weight ratio of hemicellulose and cellulose is 3.11 and the weight ratio of hemicellulose and lignin is 23.0. The cellulose/lignin weight ratio is 7.40.

The protein fraction further comprises 55.3 wt % protein, 16 wt % fat, 2.2 wt % crude ash and 2.8 wt % water. The protein/fat weight ratio is 3.46. The protein-containing composition comprises 1.6 wt % crude fiber which is very low compared to conventional protein fractions obtained from BSG. Moreover, the protein fraction comprises 10 ppm gluten rendering it a gluten-free protein product. The d90 of the particles in the protein-containing composition is 61 μm.

The protein-containing composition contained 71.1% of ruptured cells, based on the total number of aleurone cells as determined using scanning electron microscopy (see method below). The total number of aleurone cells assessed were 38 (in 20 SEM images of the protein-containing composition). The protein-containing composition comprised mainly of free protein.

### Fine Fiber Composition

The dried fine fiber composition has a total dietary fiber fraction of 58.0 wt %, with an insoluble HMWDF of 56.3 wt % and a soluble HMWDF of 1.7 wt %. These values were also measured with the standard method AOAC 2011.25.

The fine fiber fraction is further characterized by an NDF value of 654 g per kg dry weight, an ADF value of 204 g per kg dry weight and an ADL value of 46 g per kg dry weight. Converted, the protein fraction comprises 15.8 wt % cellulose, 45.0 wt % hemicellulose and 4.6 wt % lignin. The weight ratio of hemicellulose and cellulose is 2.85 and the weight ratio of hemicellulose and lignin is 9.78 The cellulose/lignin weight ratio is 3.43.

The fine fiber fraction further comprises 28.8 wt % protein, 10 wt % fat, 2.1 wt % crude ash and 5.7 wt % water. The protein/fat weight ratio is 2.88. The protein-containing composition comprises 14.4 wt % crude fiber. The d90 of the particles in the fine fiber composition is 35 μm.

### Coarse Fiber Composition

The dried coarse fiber composition has a total dietary fiber fraction of 78.0 wt %, with an insoluble HMWDF of 77.1 wt % and a soluble HMWDF of 0.9 wt %.

These values were measured using the standard method AOAC 2011.25.

The coarse fiber fraction is further characterized by an NDF value of 814 g per kg dry weight, an ADF value of 305 g per kg dry weight and an ADL value of 54 g per kg dry weight. Converted, the protein fraction comprises 25.1 wt % cellulose, 50.9 wt % hemicellulose and 5.4 wt % lignin. The weight ratio of hemicellulose and cellulose is 2.03 and the weight ratio of hemicellulose and lignin is 9.43 The cellulose/lignin weight ratio is 4.65.

The fiber fraction further comprises 13.1 wt % protein, 7.6 wt % fat, 3.2 wt % crude ash and 2.4 wt % water. The protein/fat weight ratio is 1.72. The protein-containing composition comprises 25.4 wt % crude fiber. The d90 of the particles in the coarse fiber composition is 400 μm.

The coarse fiber composition contained 43% of empty aleurone cells, based on the total number of aleurone cells as determined using confocal scanning laser microscopy. No free protein was detected.

The coarse fiber composition contained 56.8% of ruptured cells, based on the total number of aleurone cells as determined using scanning electron microscopy (see method below). The total number of aleurone cells assessed were 2553. No free protein was detected.

### Scanning Electron Microscopy

Samples with or without treatments were cryofixed in melting propane and stored in liquid nitrogen. The cryofixed samples were cryoplaned using a cryo-ultramicrotome (Leica Ultracut UCT with EMFCS, Leica Microsystems), first using a glass knife, then finishing with a diamond knife. The remaining block surface was sublimated at −80° C. until frost disappeared, and sputter coated with Platinum at −125° C. The cryoplaned surfaces were analyzed in a cryo-Scanning Electron Microscope (cryo-SEM Jeol 6490LA equipped with a Gatan Alto 2500 cryo-preparation system).

Sufficient number of images from each sample were captured (>20 images per sample, yielding at least 200-500 aleurone cells). The following features were counted: Cells surrounded by a closed cell wall, separately counted when containing either packed with dry matter or not packed with dry matter, and the same was done for cells that were not completely surrounded by a closed cell wall. Free particles that were recognized as former aleurone cell contents were counted as well.

Processing of each individual image was done using Fiji, an official distribution of ImageJ open-source software. In brief, automatic particle measurement (in this case particles are defined as cytoplasmatic protein) was started after preliminary segmentation. The particles were distinguished from the background by defining a specific threshold level. Next measurements were performed on segmented images. In brief, the total number of particles, area of individual particles, total area of particles, and percentage of total area of particles in comparison to background were measured.

### Confocal Scanning Laser Microscopy

The sample was wetted with a drop of 1% (w/v) glutaraldehyde. Small pieces of the sample paste were embedded in 1% agar, fixed in 1% glutaraldehyde in 0.1 M phosphate buffer, pH 7.0, dehydrated in a graded ethanol series and embedded in Technovit 7100 as recommended by the manufacturer (Kulzer GmbH, Wehrheim, Germany). Fixed samples were sectioned (2 μm sections) in a rotary microtome using a glass knife. Microscopic examination was done using the autofluorescence of the material, using a Confocal Laser Scanning Microscope (Leica SP5, Leica Mikrosysteme Vertrieb GmbH, Wetzlar, Germany). The following settings were applied: Excitation wavelengths: 405 nm, 458 nm, and 561 nm; Emission detection: 412-456 nm (cyan channel), 467-554 nm (green channel), and 575-790 nm (red channel). The channels were merged to create RGB-images.

### EXAMPLE 2: PASTA

For the production of pasta strands comprising the aforementioned coarse fiber composition and the protein-containing composition from Example 1 with the following composition (in g/100 g):

### Dry Mix:

| | |
|---|---|
| Coarse fiber composition of Example 1 | 30.0 |
| Semolina flower | 68.0 |
| Gluten powder | 2.0 |

### Liquid Mix:

| | |
|---|---|
| Whole egg | 26.7 |
| Water | 32.5 |

### Preparation of the Pasta:

Mix the dry ingredients
Mix the liquid ingredients
Place the dry ingredients in the extruder
Put the extruder in the kneading position.
Slowly add the liquid ingredients
Blend for 5 minutes:
Put the extruder in the extrude position
Cut the pasta to the desired length
Boil the pasta in water for 5 minutes in a 1:10 ratio (pasta:water)

### Analysis

To compare the different compositions, the firmness and stickiness were compared using the Stable microsystems Texture analyzer. For strength, 5 strands of pasta were cut with a perspex knife blade (test was repeated 5 times). To determine the stickiness, the pasta stickiness rig was used, in which 5 strands of pasta were used each time (test was repeated 5 times).

The tests were all performed with cooked pasta, 5 minutes after draining the cooking liquid.

The pasta made with the coarse fiber composition of Example 1 has good strength, does not break easily and comprises acceptable stickiness. The pasta now has more coarse fiber that may be positive for the gut microbiota.

The same pasta is made with the protein-containing composition of Example 1 instead of the coarse fiber composition of Example 1. Also from this a good pasta can be made, the pasta having a greater firmness and a lower stickiness than the pasta made with the fiber fraction. In addition, these pastas are more flexible and break even less quickly.

### EXAMPLE 3: BROWN BREAD

Brown bread comprising the protein-containing composition from Example 1 are manufactured with the following composition (in g):

| | |
|---|---|
| Protein-containing composition of Example 1 | 250 |
| Flower Orchid | 1000 |
| Flour Linden | 1250 |
| Water | 1950 |
| Yeast | 62.5 |
| NaCl | 37.5 |
| Gluten powder | 125.0 |
| Malt powder | 50.0 |
| BV M Sonplus brown | 75.0 |
| Calcium propionate | 7.5 |

### Preparation of the Bread:

Kneader used: Diosna, spiral kneader type.
Mix dry ingredients in the kneader: 1 min. setting 1.
Dissolve calcium propionate in the water and add. Only add 220 g of water after kneading for 5 minutes on level 2.
Mixing: 5 min. speed 1. (kneading strokes: 102 per minute)
Kneading: 9.5 min. setting 2. (kneading strokes: 216 per minute)
Bulk grey: 10 min. in a climate chamber 36° C./85% RH.
Weighing: 4 pieces of dough of 900 g. and bulge loosely.
Bulb rice: 45 min. in a climate chamber 36° C./85% RH.
Calmly degas dough pieces by hand and lay them out with the make-up machine.
Place pieces of dough in the greased bread pairs. Dimensions of bread pairs: 27 cm length.
Naris: 60 min. in a climate chamber 36° C./85% RH.
Baking: insert temperature 280° C., burner position 3. Hood temp. at 250° C. and floor temp. set at 240° C. steaming.
Baking time: 35 min.
Cool down: 1.5 hours
Packaging: store in plastic and ambient.

A bread made with the protein-containing composition of Example 1 has a nice texture and has risen well. The bread has good tenderness. This example shows that part of the flour can be replaced with the protein-containing composition of Example 1.

### EXAMPLE 4: COOKIES

Biscuits comprising the fine fiber composition from Example 1 can be manufactured with the following composition (in g):

| | |
|---|---|
| Fine fiber composition of Example 1 | 11.78 |
| Flower Meneba Kingfisher | 37.12 |
| Whole wheat flour Meneba Linde | 8 |
| Sugar | 14.15 |
| Water | 7.2 |
| Margarine Trio pure Soft | 17.35 |
| NaCl | 0.55 |
| Vercosine 70 DM | 1.85 |
| Baking powder | 0.4 |
| Soy lectithin | 0.4 |
| Sodium bicarbonate | 0.95 |
| Ammonium bicarbonate | 0.25 |

### Preparation of the Biscuit:

Mix granulated sugar, vercosine, margarine and soy lecithin together for 1 min on 1st speed in Hobart mixer with butterfly stirrer
Dissolve the baking salts and powders in water and add to the Hobart
Mix for 1 minute on the 1st setting
Add the flour mixture and mix for 1 minute or speed 1 and 30 seconds on speed 2
Roll out the dough to a thickness of 3 mm and cut out with a round shape with a diameter of 60 mm
Baking: 180 degrees Celsius, 17 minutes
Cooling and packing

The biscuits obtained with the fine fiber composition of Example 1 have an airy and brittle structure. The cookies rise well during baking. The measurements with a Texture analyzer (3 point bend test) show that the biscuits require more force to break than a comparable reference product, in which no fine fiber composition of Example 1 is used. This Example 4 shows that the flour can partly (about 25 wt %) be replaced by the flour in biscuits, whereby the biscuits are richer in fiber.

The present invention is by no means limited to the embodiments described by way of example and shown in the Figures, but a method according to the invention can be implemented in all kinds of devices with process units without departing from the scope of the invention as defined in the following claims.

For example, the order of the processed process units can still change depending on the type of cereal grain being treated, but the same process units are always run through. It uses the correlation between the fiber structure, the concentration of bound and encapsulated protein, and the sieve, press and hammer mill configurations.

### EXAMPLE 5: ENZYMATIC PROCESS

To 30 g of the coarse fiber composition of Example 1 270 g water was added and the combination was mixed. The suspension was brought to a temperature of 50° C. Subsequently, 0.3 g of enzyme was added to the suspension and maintained for 24 hours. After the 24-hour incubation time, the suspension was sieved over a 200 μm screen and washed. Water was removed from the fibers using a vacuum press. The amount of protein in the fiber composition were determined using the Kjeldahl method and tabulated below. Also the type of enzyme used in this example is indicated in the Table.

TABLE 1
Enzymes and resulting protein content in coarse fiber composition

| | Protein content |
|---|---|
| Enzyme | (wt %) |
| Viscozyme | 9.9 |
| Ultraflo XL | 9.8 |
| Depol 740L | 5.3 |
| Cellic Ctec2 | 5.5 |
| Cellic Ctec2 and Depol 740L (1/1 w/w) | 5.2 |
| Cellic Ctec2 and Viscozyme (1/1 w/w) | 5.2 |

From the results in Table 1 it can be deduced that the various commercial enzymes lead to a lowering of the total protein content, even to levels below 6 wt % (and consequently less than 1 wt % nitrogen).

1-12. (canceled)

13. A composition comprising any one of: one or more fibers of cereal grains, a protein of a cereal grain, or combinations thereof,
wherein the composition comprises at least 10% of empty aleurone cells, based on the total number of aleurone cells.

14. The composition of claim 13, wherein the composition is a coarse fiber composition of cereal grains.

15. The composition of claim 14, wherein the coarse fiber composition comprises at least 65% by weight of insoluble high molecular weight dietary fibers (HMWDF) and less than 15% by weight of protein, based on the total dry weight of the coarse fiber composition.

16. The coarse fiber composition of claim 15, wherein the coarse fiber composition comprises a minimum of 20% by weight of cellulose, a minimum of 40% by weight of hemicellulose and a minimum of 4% by weight of lignin, based on the total dry weight of the coarse fiber composition.

17. The composition of claim 13, wherein the composition is a fine fiber composition comprising fibers of cereal grains, wherein the fine fiber composition comprises at least 50% and at most 70% by weight of insoluble high molecular weight dietary fibers (HMWDF), based on the total dry weight of the fine fiber composition, and wherein the fine fiber composition comprises at most 20% by weight of cellulose, based on the total dry weight of the fine fiber composition.

18. The fine fiber composition of claim 17, wherein the fine fiber composition comprises at least 40% by weight of hemicellulose and at least 4% by weight of lignin, based on the total dry weight of the fine fiber composition.

19. The composition of claim 13, wherein the composition is a protein-containing composition comprising proteins of the cereal grain, characterized in that the protein-containing composition comprises at most 30% by weight of insoluble high molecular weight dietary fibers (HMWDF), at least 50% by weight proteins and at most 3% by weight of lignin, based on the total dry weight of the protein-containing composition.

20. The protein-containing composition according to claim 19, wherein the protein-containing composition comprises at least 15% by weight of glutamine, based on the total dry weight of proteins in the protein-containing composition.

21. The composition of claim 13, wherein the composition is a mixture comprising a fine fiber composition comprising fibers of cereal grains, wherein the fine fiber composition comprises at least 50% by weight and at most 70% by weight of insoluble high molecular weight dietary fibers (HMWDF), based on the total dry weight of the fine fiber composition, and wherein the fine fiber composition comprises at most 20% by weight of cellulose, based on the total dry weight of the fine fiber composition and a protein-containing composition comprising proteins of the cereal grain, characterized in that the protein-containing composition comprises at most 30% by weight of insoluble HMWDF, at least 50% by weight proteins and at most 3% by weight of lignin, based on the total dry weight of the protein-containing composition.

22. The composition of claim 13, wherein the composition is a mixture comprising a fine fiber composition comprising fibers of cereal grains, characterized in that the fine fiber composition comprises at least 50% and at most 70% by weight of insoluble high molecular weight dietary fibers (HMWDF), based on the total dry weight of the fine fiber composition, and wherein the fine fiber composition comprises at most 20% by weight of cellulose, based on the total dry weight of the fine fiber composition and a coarse fiber composition comprising coarse fibers of cereal grains, characterized in that the coarse fiber composition comprises at least 65% by weight of insoluble HMWDF and less than 15% by weight of protein, based on the total dry weight of the coarse fiber composition.

23. The composition of claim 13, wherein the composition is a mixture comprising a coarse fiber composition comprising coarse fibers of cereal grains, characterized in that the coarse fiber composition comprises at least 65% by weight of insoluble high molecular weight dietary fibers (HMWDF) and less than 15% by weight of protein, based on the total dry weight of the coarse fiber composition and a protein-containing composition comprising proteins of the cereal grain, characterized in that the protein-containing composition comprises at most 30% by weight of insoluble HMWDF, at least 50% by weight of proteins and at most 3 wt % lignin, based on the total dry weight of the protein-containing composition.

24. A method for processing cereal grains, the method comprising washing a cereal grain, wherein protein is separated from the cereal grains to obtain a first protein-containing liquid and the cereal grain.

25. The method of claim 24, further comprising the step of removing water from the cereal grain to obtain a cereal grain suspension containing 1% to 30% by weight of the cereal grain, based on the total weight of the suspension, and obtaining a second protein-containing liquid

26. The method of claim 24, further comprising the step of treating a suspension of cereal grains containing 1% to 30% by weight of the cereal grain with a high shear mill to at least partially release protein encapsulated in the aleurone cells, and to obtain a ground cereal grain fiber.

27. The method of claim 25, further comprising the step of treating a suspension of cereal grains containing 1% to 30% by weight of the cereal grain with a high shear mill to at least partially release protein encapsulated in the aleurone cells, and obtaining a ground cereal grain fiber.

28. The method of claim 24, wherein the cereal grain is brewer's spent grain.

29. The method of claim 24, further comprising the steps of separating the ground cereal grain fiber in a rotary sieve or a centrifugal sieve from a third protein-containing liquid whereby the ground cereal grain fiber is sprayed with water; removing water from the ground fiber in a press to obtain a coarse fiber composition and a fourth protein-containing liquid, and drying the coarse fiber composition; and combining the first, second, third or fourth protein-containing liquids separately or in combination to form one protein-containing liquid and separating the protein from water to obtain a protein-containing composition,

30. The method of claim 29, wherein the protein-containing composition is dried.

31. The method of claim 29, wherein the water is removed from the ground fiber in a screw press or in a chamber filter press.

32. The method according to claim 29, further comprising the step of centrifuging and filtering the protein-containing liquid to obtain a fine fiber composition and a protein-containing composition.

33. The method of claim 32, further comprising the step of drying compositions separately or in combination.
